(19) United States
(12) Patent Application Publication
(10) Pub. No.: US 2019/0005667 A1
(43) Pub. Date: Jan. 3, 2019

(54) Ground Surface Estimation

(71) Applicant: Muhammad Zain Khawaja, Milton Keynes (GB)

(72) Inventor: Muhammad Zain Khawaja, Milton Keynes (GB)

(21) Appl. No.: 16/043,182

(22) Filed: Jul. 24, 2018

Related U.S. Application Data
(60) Provisional application No. 62/536,196, filed on Jul. 24, 2017.

(51) Int. Cl. G06T 7/536; G06K 9/00

(52) U.S. Cl. CPC G06T 7/536; G06T 2207/30256; G06T 2207/10028; G06K 9/00798

(57) ABSTRACT

Systems and methods are provided for ground surface estimation by an autonomous vehicle. In one implementation, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile.

### CROSS REFERENCE TO RELATED APPLICATIONS

This application claims the benefit of the priority of U.S. Provisional Patent Application No. 62/536,196 filed on Jul. 24, 2017.

### BACKGROUND

### Technical Field

The present disclosure relates generally to ground surface estimation by an autonomously operating ground vehicle. Additionally, this disclosure relates to systems and methods for developing a ground surface estimation using on-vehicle sensors acquiring three-dimensional data that is representative of the environment of the vehicle.

### Background Information

Knowledge of the ground topography and road structure is a critical requirement for autonomous vehicles. For full commercial deployment of autonomous vehicles, it will be necessary for autonomous vehicles to be able to interpret and leverage vast amounts of precise information pertaining, among other things, to; the ground topography and geometric structure of various types of roads and paths, and autonomous vehicles would need to demonstrate safe and adequate vehicle actuation responses to all available information about the driving surface.

Autonomous vehicles currently utilise pre-mapped data in the form of HD maps, 3D maps, or in the form of 2D sparse maps, and these maps provide a point-in-time, pre-acquired data of some aspects of the environmental context of a geographic location which is then utilised by an autonomous vehicle in the form of location cues pertaining for example; the location of landmarks, the location of various lane markings, the location of traffic signals, the location of road signs and the location of traffic junctions, etcetera. The primary purpose of these maps is to assist the autonomous vehicle in knowing where it is located within its context and this is referred to as ‘localisation’ and in an aspect, it is an answer to the question from the perspective of an autonomous vehicle—‘where am I?’. While HD, 3D maps are a source of pre-acquired information for an autonomous vehicle and can be used for assisting the autonomous vehicle in localisation, these maps are not available for majority of the roads around the world. Developing HD, 3D maps requires that a previous ‘mapping run’ of a road has been performed, as a prior instance of detailed data acquisition through multiple sensors upon a data collection vehicle. This data is then annotated either manually or through machine learning techniques in order to make it clearly interpretable as an HD map, 3D map, or 2D sparse map, to a system of an autonomous vehicle to assist in the localisation. However, the world changes constantly and therefore these maps can become outdated, and consequently, as a result of some change in the environment, within a particular region the autonomous vehicle may not be able to localise itself till the maps have been updated. In an approach to road grade estimation provided by Sahlholm et al. fore-knowledge of the road topography is required and no optimal speed control can be performed by a vehicle on the first drive over unknown roads.

Autonomous vehicles also use a variety of on-vehicle sensors to achieve an understanding of their environmental context. Using on vehicle sensors, autonomous vehicles perform the ‘sensing’ task in order to perceive and interpret what is around the vehicle at any given time. In an aspect, the sensing task and the localisation task go hand-in-hand as it is on the basis of matching up the live sensor data with the pre-acquired map data that the autonomous vehicle achieves localisation.

The sensing task also has to provide answers to the question, from the perspective of the autonomous vehicle—‘what is around me?’. On-vehicle sensors are accordingly employed in an attempt to; detect and recognise obstacles in the path of the vehicle, and to detect and classify the drivable free space upon which the autonomous vehicle can drive. Classifying the drivable free space is sometimes achieved through machine learning approaches such as semantic segmentation. However, robust results are not being achieved given the current state of the art even though 3D data of the environment is available to the vehicle through its on-board vehicle sensors such as LIDARs and stereo cameras.

Within the sensing task, ground surface estimation has remained a major bottleneck for autonomous vehicles. If the slope angle of the road varies too much or if a vehicle is to drive upon a road within a hilly terrain, where high variability in road geometry is present all along the route, the challenge is compounded in comparison to driving upon a perfectly flat and well-made road. Similarly, when encountering a descent, an autonomous vehicle's sensing system can be highly deficient in performing the ground sensing task if it is relying on various types of flat-ground, or planarity assumptions for determining the ground surface. In various other emerging classes of autonomous mobility platforms, other than on-road autonomous vehicles, such as; autonomous warehouse trucks, autonomous construction equipment and autonomous delivery vehicles, the vehicles face further challenges in terms of ground surface estimation, in each of their unique operational contexts. These vehicles may have to contend with unknown profiles of; ramps, speed bumps, footpaths, ditches, driveways, and outdoor dirt tracks as well. In the approach presented by Ingle et al. it is assumed that the user has a prior reliable estimate of the minimum and maximum possible slopes and Markovian assumptions are imposed on the sequence of slope value.

Existing approaches for ground surface estimation through vehicle on-board 3D sensors, fail to recognize parts of the ground surface, and many of the existing approaches for autonomous mobility in relation to ground surface estimation, are based on too many simplifying assumptions regarding the ground surface, such as; planarity, continuity, appearance homogeneity, edge demarcation, lane markings etcetera, which still fail in not only edge cases but in regularly encountered scenarios as well. The ability to accurately and robustly estimate the ground surface in real time also presents computational challenges related to acquiring and processing three-dimensional data pertaining to the ground surface when significant computing resources of an autonomous vehicle are already addressing three-dimensional, multi-sensor data in relation to; detecting, classifying, tracking and avoiding various types and categories of static and dynamic obstacles along its path. Thus, a robust ground surface estimate, which caters to a large and unanticipated level of unpredictability of the ground surface and does not depend on the availability of prior environmental context information as may be stored in a 3D map, is essential for all types of autonomous vehicles in order to enable safe application of autonomous driving capability.

### SUMMARY

Embodiments consistent with the present disclosure provide systems and methods for ground surface estimation by an autonomous vehicle. The disclosed embodiments may use any type of LIDAR sensors as on-vehicle sensors being mounted anywhere upon the autonomous vehicle, in order to acquire three-dimensional, pointcloud data representing the environment of the autonomous vehicle. The disclosed embodiments may use any type of stereo cameras, or two or more monocular cameras functioning together as a stereo rig, as on-vehicle sensors being mounted anywhere upon or within the autonomous vehicle, in order to acquire three-dimensional, pointcloud data representing the environment of the autonomous vehicle. The disclosed systems and methods may develop any number of various types of ground surface estimates of any small, portion of the ground, or of any larger, region of the ground, on the basis of analysing the pointcloud data that may be captured from the on-vehicle sensor while having any perspective of view around the autonomous vehicle. Accordingly, the disclosed systems and methods may provide various types of ground surface estimates to any actuation system of the autonomous vehicle. The disclosed systems and methods may provide various types of ground traversability scores to any actuation system of the autonomous vehicle.

In one implementation, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane wherein the any pointcloud data points of the point cloud are referenced within the pointcloud in terms of, a three-dimensional Cartesian coordinate frame having a point of origin and an orientation, as determined with respect to a chosen point on the autonomous vehicle; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane wherein referencing within the pointcloud, the any pointcloud data points of the point cloud, in terms of a three-dimensional Cartesian coordinate frame having a point of origin and an orientation, as determined with respect to a chosen point on the autonomous vehicle; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane wherein the any pointcloud data points of the point cloud are referenced within the pointcloud in terms of, a three-dimensional Polar coordinate frame having a point of origin and an orientation, as determined with respect to a chosen point on the autonomous vehicle; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane wherein referencing within the pointcloud, the any pointcloud data points of the point cloud, in terms of a three-dimensional Polar coordinate frame having a point of origin and an orientation, as determined with respect to a chosen point on the autonomous vehicle; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; apply a smoothing function to the any number of piece-wise linear estimates from among the plurality of piece-wise linear estimates of the ground profile, to thereby determine a smoothed ground profile estimate upon the virtual plane.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; applying a smoothing function to the any number of piece-wise linear estimates from among the plurality of piece-wise linear estimates of the ground profile, thereby determining a smoothed ground profile estimate upon the virtual plane.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane either through orthographic projection or through radial projection; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane either through orthographic projection or through radial projection; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface; determine a composited, piece-wise linear estimate of the ground profile by associating, two or more piece-wise linear estimates, from two or more consecutive depth sections belonging to the sequence of any number of depth sections upon the virtual plane; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface; determining a composited, piece-wise linear estimate of the ground profile by associating, two or more piece-wise linear estimates, from two or more consecutive depth sections belonging to the sequence of any number of depth sections upon the virtual plane; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface, wherein any piece-wise linear estimate from among the plurality of piece-wise linear estimates, is characterised through a slope angle; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface, wherein characterising any piece-wise linear estimate from among the plurality of piece-wise linear estimates, through a slope angle; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface, wherein any piece-wise linear estimate from among the plurality of piece-wise linear estimates, is characterised through a slope angle; calculate, a ground surface estimate by combining, any number of piece-wise linear estimates from among the plurality of piece-wise linear estimates of the ground profile; assign a piece-wise traversability score to any part of the ground surface, based on the slope angle characterising a piece-wise linear estimate.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface, wherein characterising any piece-wise linear estimate from among the plurality of piece-wise linear estimates, through a slope angle; calculating, a ground surface estimate by combining, any number of piece-wise linear estimates from among the plurality of piece-wise linear estimates of the ground profile; assigning a piece-wise traversability score to any part of the ground surface, based on the slope angle characterising a piece-wise linear estimate.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface, wherein any piece-wise linear estimate from among the plurality of piece-wise linear estimates, is characterised through a slope angle; calculate, a ground surface estimate by combining, any number of piece-wise linear estimates from among the plurality of piece-wise linear estimates of the ground profile; assign a piece-wise traversability score to any part of the ground surface, based on the slope angle characterising a piece-wise linear estimate; provide, a ground traversability score or the piece-wise traversability score, as an input to the autonomous vehicle while determining an actuation command for the autonomous vehicle.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface, wherein characterising any piece-wise linear estimate from among the plurality of piece-wise linear estimates, through a slope angle; calculating, a ground surface estimate by combining, any number of piece-wise linear estimates from among the plurality of piece-wise linear estimates of the ground profile; assigning a piece-wise traversability score to any part of the ground surface, based on the slope angle characterising a piece-wise linear estimate; providing, a ground traversability score or the piece-wise traversability score, as an input to the autonomous vehicle while determining an actuation command for the autonomous vehicle.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface; determine a composited, piece-wise linear estimate of the ground profile by associating, two or more piece-wise linear estimates, from two or more consecutive depth sections belonging to the sequence of any number of depth sections upon the virtual plane, wherein the associating, of, the two or more piece-wise linear estimates, is by using, an end-point of a piece-wise linear estimate upon a first depth section as a beginning-point-of-origin for determining a piece-wise linear estimate upon a next, sequential depth section; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface; determining a composited, piece-wise linear estimate of the ground profile by associating, two or more piece-wise linear estimates, from two or more consecutive depth sections belonging to the sequence of any number of depth sections upon the virtual plane, wherein the associating, of, the two or more piece-wise linear estimates, is by using, an end-point of a piece-wise linear estimate upon a first depth section as a beginning-point-of-origin for determining a piece-wise linear estimate upon a next, sequential depth section; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section, wherein the maximal line segment is determined for selection, by counting the number of transformed, pointcloud data points of the pointcloud that may be lying within a search region being associated with each of the candidate line segments within the depth section, and therein, the maximal line segment would be the candidate line segment having the maximum count as per said counting; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section, wherein the maximal line segment is determined for selection, by counting the number of transformed, pointcloud data points of the pointcloud that may be lying within a search region being associated with each of the candidate line segments within the depth section, and therein, the maximal line segment would be the candidate line segment having the maximum count as per said counting; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section, wherein the maximal line segment is determined for selection, by counting the number of transformed, pointcloud data points of the pointcloud that may be lying within a search region being associated with each of the candidate line segments within the depth section, wherein the search region being associated with each candidate line segment is defined on the basis of a uniformly determined search distance threshold value, and therein, the maximal line segment would be the candidate line segment having the maximum count as per said counting; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section, wherein the maximal line segment is determined for selection, by counting the number of transformed, pointcloud data points of the pointcloud that may be lying within a search region being associated with each of the candidate line segments within the depth section, wherein the search region being associated with each candidate line segment is defined on the basis of a uniformly determined search distance threshold value, and therein, the maximal line segment would be the candidate line segment having the maximum count as per said counting; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; transform, any pointcloud data points of the pointcloud on to a virtual plane; section, the virtual plane into a sequence of any number of depth sections; analyse, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section, wherein the maximal line segment is determined for selection, by counting the number of transformed, pointcloud data points of the pointcloud that may be lying within a search region being associated with each of the candidate line segments within the depth section, wherein the search region being associated with each candidate line segment is defined on the basis of a uniformly determined search distance threshold value wherein the search distance threshold value is a perpendicular distance from a candidate line segment, and therein, the maximal line segment would be the candidate line segment having the maximum count as per said counting; calculate, a ground surface estimate by combining, any number of piece-wise linear estimates from among the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; transforming, any pointcloud data points of the pointcloud on to a virtual plane; sectioning, the virtual plane into a sequence of any number of depth sections; analysing, a plurality of depth sections to determine correspondingly a plurality of piece-wise linear estimates of the ground profile of various parts of the ground surface, wherein a piece-wise linear estimate of the ground profile is determined, by selecting, a maximal line segment from among a set of candidate line segments upon a depth section, wherein the maximal line segment is determined for selection, by counting the number of transformed, pointcloud data points of the pointcloud that may be lying within a search region being associated with each of the candidate line segments within the depth section, wherein the search region being associated with each candidate line segment is defined on the basis of a uniformly determined search distance threshold value wherein the search distance threshold value is a perpendicular distance from a candidate line segment, and therein, the maximal line segment would be the candidate line segment having the maximum count as per said counting; calculating, a ground surface estimate by combining, any number of piece-wise linear estimates from among the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; apply a smoothing function to the any number of piece-wise linear estimates from among the plurality of piece-wise linear estimates of the ground profile, to thereby determine a smoothed ground profile estimate upon the virtual plane.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; applying a smoothing function to the any number of piece-wise linear estimates from among the plurality of piece-wise linear estimates of the ground profile, to thereby determine a smoothed ground profile estimate upon the virtual plane.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; apply a smoothing function to the any number of piece-wise linear estimates from among the plurality of piece-wise linear estimates of the ground profile, to thereby determine a smoothed ground profile estimate upon the virtual plane; develop a ground traversability map by joining, two or more smoothed ground profile estimates being respectively from, two or more virtual planes.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; applying a smoothing function to the any number of piece-wise linear estimates from among the plurality of piece-wise linear estimates of the ground profile, to thereby determine a smoothed ground profile estimate upon the virtual plane; developing a ground traversability map by joining, two or more smoothed ground profile estimates being respectively from, two or more virtual planes.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; develop a ground traversability map by joining, two or more of the plurality of piece-wise linear estimates of the ground profile being respectively from two or more virtual planes.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; developing a ground traversability map by joining, two or more of the plurality of piece-wise linear estimates of the ground profile being respectively from two or more virtual planes.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; develop a ground traversability map by joining, two or more of the plurality of piece-wise linear estimates of the ground profile being respectively from two or more virtual planes; assign a ground traversability score to any location upon the ground traversability map.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; developing a ground traversability map by joining, two or more of the plurality of piece-wise linear estimates of the ground profile being respectively from two or more virtual planes; assigning a ground traversability score to any location upon the ground traversability map.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; apply a smoothing function to the any number of piece-wise linear estimates from among the plurality of piece-wise linear estimates of the ground profile, to thereby determine a smoothed ground profile estimate upon the virtual plane; develop a ground traversability map by joining, two or more smoothed ground profile estimates being respectively from, two or more virtual planes; assign a ground traversability score to any location upon the ground traversability map.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; applying a smoothing function to the any number of piece-wise linear estimates from among the plurality of piece-wise linear estimates of the ground profile, to thereby determine a smoothed ground profile estimate upon the virtual plane; developing a ground traversability map by joining, two or more smoothed ground profile estimates being respectively from, two or more virtual planes; assign a ground traversability score to any location upon the ground traversability map.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; apply a smoothing function to the any number of piece-wise linear estimates from among the plurality of piece-wise linear estimates of the ground profile, to thereby determine a smoothed ground profile estimate upon the virtual plane; develop a ground traversability map by joining, two or more smoothed ground profile estimates being respectively from, two or more virtual planes; assign a ground traversability score to any location upon the ground traversability map, wherein the ground traversability score is derived from the slope angle of the one or more of the plurality of piece-wise linear estimates of the ground profile.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; applying a smoothing function to the any number of piece-wise linear estimates from among the plurality of piece-wise linear estimates of the ground profile, to thereby determine a smoothed ground profile estimate upon the virtual plane; developing a ground traversability map by joining, two or more smoothed ground profile estimates being respectively from, two or more virtual planes; assign a ground traversability score to any location upon the ground traversability map, wherein deriving the ground traversability score from the slope angle of the one or more of the plurality of piece-wise linear estimates of the ground profile.

In some embodiments, a system for ground surface estimation by an autonomous vehicle may include at least one processing device programmed to: receive, from a sensor mounted on the autonomous vehicle, a pointcloud that is representative of an environment of the autonomous vehicle; allocate any pointcloud data points as pointcloud data points belonging within a particular segment wherein the particular segment may be from among a determined plurality of contiguous segments of the pointcloud; transform, any pointcloud data points of the particular segment on to a virtual plane; section, the virtual plane into a sequence of any number of depth sections; analyse, a plurality of depth sections to determine correspondingly a plurality of piece-wise linear estimates of the ground profile of various parts of the ground surface; calculate, a ground surface estimate by combining, any number of piece-wise linear estimates from among the plurality of piece-wise linear estimates of the ground profile; apply a smoothing function to the any number of piece-wise linear estimates from among the plurality of piece-wise linear estimates of the ground profile, to thereby determine a smoothed ground profile estimate upon the virtual plane; develop a ground traversability map by joining, two or more smoothed ground profile estimates being respectively from, two or more virtual planes; assign a ground traversability score to any location upon the ground traversability map, wherein the ground traversability score is derived from the slope angle of the one or more of the plurality of piece-wise linear estimates of the ground profile; provide the ground traversability score or a piece-wise traversability score as an input to the autonomous vehicle while determining an actuation command for the autonomous vehicle.

In some embodiments, a method for ground surface estimation by an autonomous vehicle may include: receiving, from a sensor mounted on the autonomous vehicle, a pointcloud that is representative of an environment of the autonomous vehicle; allocating any pointcloud data points as pointcloud data points belonging within a particular segment wherein the particular segment may be from among a determined plurality of contiguous segments of the pointcloud; transforming, any pointcloud data points of the particular segment on to a virtual plane; sectioning, the virtual plane into a sequence of any number of depth sections; analysing, a plurality of depth sections to determine correspondingly a plurality of piece-wise linear estimates of the ground profile of various parts of the ground surface; calculating, a ground surface estimate by combining, any number of piece-wise linear estimates from among the plurality of piece-wise linear estimates of the ground profile; applying a smoothing function to the any number of piece-wise linear estimates from among the plurality of piece-wise linear estimates of the ground profile, to thereby determine a smoothed ground profile estimate upon the virtual plane; developing a ground traversability map by joining, two or more smoothed ground profile estimates being respectively from, two or more virtual planes; assign a ground traversability score to any location upon the ground traversability map, wherein deriving the ground traversability score from the slope angle of the one or more of the plurality of piece-wise linear estimates of the ground profile; providing the ground traversability score or a piece-wise traversability score as an input to the autonomous vehicle while determining an actuation command for the autonomous vehicle.

Consistent with other disclosed embodiments, non-transitory computer-readable storage media may store program instructions, which are executed by at least one processing device and perform any of the methods described herein.

The foregoing general description and the following detailed description are exemplary and explanatory only and are not restrictive of the claims.

### BRIEF DESCRIPTION OF DRAWINGS

The accompanying drawings, which are incorporated in and constitute part of this disclosure, illustrate various embodiments. In the drawings:

FIG. 1 is a diagrammatic representation of an exemplary system consistent with the disclosed embodiments.

FIG. 2 is a diagrammatic representation of exemplary vehicle control systems consistent with the disclosed embodiments.

FIG. 3 is an illustration of a front view of an exemplary autonomous vehicle including a system consistent with the disclosed embodiments.

FIG. 4 is an illustration of a front view of another exemplary autonomous vehicle including a system consistent with the disclosed embodiments.

FIG. 5 is an illustration of a front view of another exemplary autonomous vehicle including a system consistent with the disclosed embodiments.

FIG. 6 is an illustration of a front view of another exemplary autonomous vehicle including a system consistent with the disclosed embodiments.

FIG. 7 is a diagrammatic top-down view representation of a potential pointcloud region being with respect to the exemplary autonomous vehicle shown in FIG. 5 consistent with the disclosed embodiments.

FIG. 8 is a diagrammatic top-down view representation of a radial pointcloud oriented towards the front of, an exemplary autonomous vehicle, and being within the potential pointcloud region shown in FIG. 7 consistent with the disclosed embodiments.

FIG. 9 is a diagrammatic top-down view representation of a cuboid pointcloud oriented towards the front of, an exemplary autonomous vehicle, and being within the potential pointcloud region shown in FIG. 7 consistent with the disclosed embodiments.

FIG. 10 is a diagrammatic top-down view representation of a cuboid pointcloud oriented towards the left side of, an exemplary autonomous vehicle, and being within the potential pointcloud region shown in FIG. 7 consistent with the disclosed embodiments.

FIG. 11 is a diagrammatic top-down view representation of a radial pointcloud oriented towards the left side of, an exemplary autonomous vehicle, and being within the potential pointcloud region shown in FIG. 7 consistent with the disclosed embodiments.

FIG. 12 is a diagrammatic top-down view representation of a potential pointcloud region being with respect to the exemplary autonomous vehicle shown in FIG. 3 consistent with the disclosed embodiments, and herein showing a radial pointcloud oriented towards the front of the exemplary vehicle, consistent with the disclosed embodiments.

FIG. 13 is a diagrammatic top-down view representation of a potential pointcloud region being with respect to the exemplary autonomous vehicle shown in FIG. 3 consistent with the disclosed embodiments, and herein showing a cuboid pointcloud oriented towards the front of the exemplary vehicle, consistent with the disclosed embodiments.

FIG. 14 is a diagrammatic, three-dimensional representation of an exemplary cuboid pointcloud, consistent with the disclosed embodiments.

FIG. 15 is a diagrammatic, three-dimensional representation of the same exemplary cuboid pointcloud as shown in FIG. 14 including exemplary segments, consistent with the disclosed embodiments.

FIG. 16 is a diagrammatic, three-dimensional representation of one of the exemplary segments shown in FIG. 15, consistent with the disclosed embodiments.

FIG. 17 is a diagrammatic, three-dimensional representation of the same exemplary segment as shown in FIG. 16 and herein showing a pointcloud data point having been allocated as belonging within the particular segment, and the location of a transformed, pointcloud data point on to a virtual plane of the exemplary segment, consistent with the disclosed embodiments.

FIG. 18 is a diagrammatic representation of a side-edge view of the virtual plane referenced in FIG. 17 consistent with the disclosed embodiments.

FIG. 19 is a diagrammatic representation of a top-edge view of the same virtual plane referenced in FIG. 17 consistent with the disclosed embodiments.

FIG. 20 is a diagrammatic representation of a full planar view of the same virtual plane referenced in FIG. 17 consistent with the disclosed embodiments.

FIG. 21 is a diagrammatic representation of a full planar view version of the same virtual plane referenced in FIG. 17, if exemplary cuboid pointcloud referenced in FIG. 14 were acquired using a higher resolution sensor, consistent with the disclosed embodiments.

FIG. 22 is a diagrammatic representation of a full planar view version of virtual plane as shown in FIG. 21, sectioned into a sequence of depth sections, consistent with the disclosed embodiments.

FIG. 23 is a diagrammatic representation providing a more detailed view of one of the depth sections on the virtual plane shown in FIG. 22, and therein also showing, a transformed, pointcloud data point upon the depth section, consistent with the disclosed embodiments.

FIG. 24 is a diagrammatic representation of the depth section shown in FIG. 23, including a set of candidate line segments upon the depth section, consistent with disclosed embodiments.

FIG. 25 is a diagrammatic representation of the depth section shown in FIG. 24, but herein only showing, one of the candidate line segments and an exemplary search region, consistent with disclosed embodiments.

FIG. 26 is a diagrammatic representation of the depth section shown in FIG. 24, herein only showing, another one of the candidate line segments and an exemplary search region, consistent with disclosed embodiments.

FIG. 27 is a diagrammatic representation of a virtual plane consistent with the disclosed embodiments, showing a maximal line segment having been determined upon each depth section upon the virtual plane, consistent with disclosed embodiments.

FIG. 28 is a diagrammatic representation of the same virtual plane as shown in FIG. 27, herein showing a smoothed ground profile estimate upon the virtual plane, consistent with disclosed embodiments.

FIG. 29 is a diagrammatic, three-dimensional representation of an exemplary radial pointcloud, consistent with the disclosed embodiments.

FIG. 30 is a diagrammatic top-view representation of a segment of the exemplary radial pointcloud shown in FIG. 29, consistent with the disclosed embodiments.

FIG. 31 is a diagrammatic representation of a full planar view of an exemplary virtual plane that has been referenced in FIG. 30, consistent with the disclosed embodiments.

FIG. 32 is a diagrammatic representation of another exemplary virtual plane that has been shown in FIG. 15, consistent with the disclosed embodiments.

FIG. 33 is a diagrammatic representation of a piece-wise linear estimate of the ground profile from an exemplary depth section shown in FIG. 27, herein being represented on a part of a ground surface within the cuboid pointcloud shown in FIG. 15, consistent with the disclosed embodiments.

FIG. 34 is a diagrammatic representation of an exemplary ground traversability map on the ground surface shown in FIG. 33.

### DETAILED DESCRIPTION

The following detailed description refers to the accompanying drawings. Several illustrative embodiments are described herein, however other implementations are possible and various modifications and adaptations are possible. For example in various implementations, modifications, substitutions and additions may be made to the listed components illustrated in the drawings. Also, the methods described herein may be modified by; reordering, substituting, removing, or adding steps to the disclosed methods. The following detailed description is accordingly, not limited to the disclosed embodiments and the proper scope is defined by the appended claims.

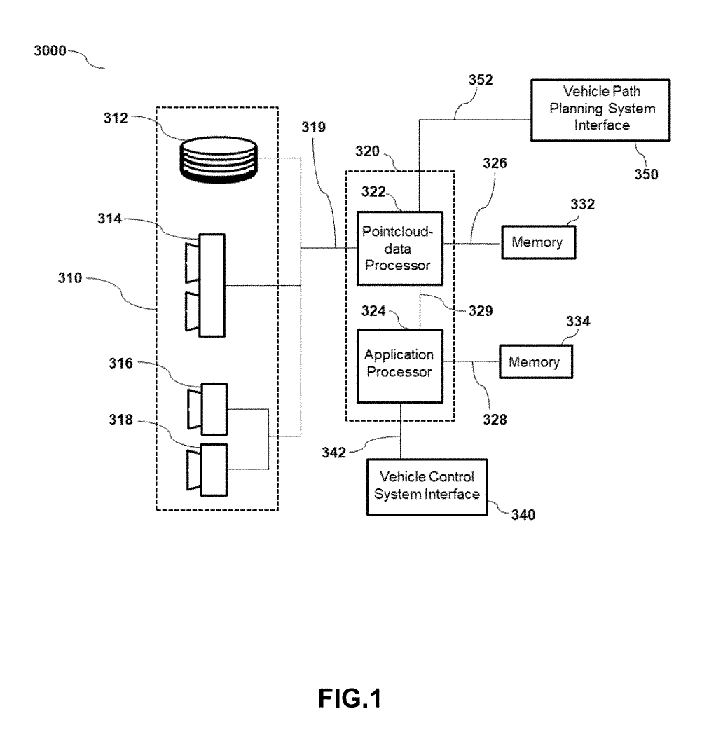

FIG. 1 is a block diagram representation of a system 3000 consistent with the exemplary disclosed embodiments. As per the requirements of various implementations, system 3000 may include various components. In some embodiments system 3000 may include a sensing unit 310, a processing unit 320, one or more memory units 332, 334, vehicle control system interface 340, and a vehicle path planning system interface 350. Sensing unit 310 may include any number of sensors, for example, any number of LIDARs such as a LIDAR 312, or any number of stereo cameras such as a stereo camera 314, or any number of stereo rigs comprising at least two of any monocular cameras such as monocular cameras 316, 318 that have been configured to collectively function as a stereo rig, or may be used as single monocular cameras to obtain a pointcloud of a scene using monocular depth estimation. Processing unit 320 may include one or more processing devices. In some embodiments, processing unit 320 may include a pointcloud-data processor 322, an applications processor 324 or any other processing device that may be suitable for the purpose. System 3000 may include a data interface 319 communicatively connecting, sensing unit 310 to processing unit 320. Data interface 319 may be any wired or wireless interface for transmitting the data acquired by sensing unit 310 to processing unit 320. In some embodiments, data interface 319 may additionally be used to trigger, any one or more of the sensors within sensing unit 310, to commence a synchronised data transmission to processing unit 320.

Memory units 332, 334, may include random access memory, read only memory, flash memory, optical storage, disk drives, or any other type of storage. In some embodiments, memory units 332, 334 may be integrated into applications processor 324 or pointcloud-data processor 322 whereas in some other embodiments, memory units 332, 334 may be separate from any processor, or memory units 332, 334 may be removable, memory units. Memory units 332, 334, may include software instructions that could be executed by pointcloud-data processor 322 or by applications processor 324. Memory units 332, 334, may be used to store any acquired, raw data stream from any of the sensors in sensing unit 310. Memory units 332, 334, may be used to store any acquired, raw pointcloud data from any of the sensors in sensing unit 310. In some embodiments, memory unit 332 may be used to store, within any database architecture, any processed pointcloud data from any intermediate stages of the various processing tasks performed by pointcloud-data processor 322. In some embodiments, memory unit 334 may be used to store any of the outputs pertaining to the various processing tasks performed by applications processor 324. In some embodiments, memory unit 332 may be operably connected with pointcloud-data processor 322 through any type of physical interface such as interface 326. In some embodiments, memory unit 334 may be operably connected with applications processor 324 through any type physical interface such as interface 328.

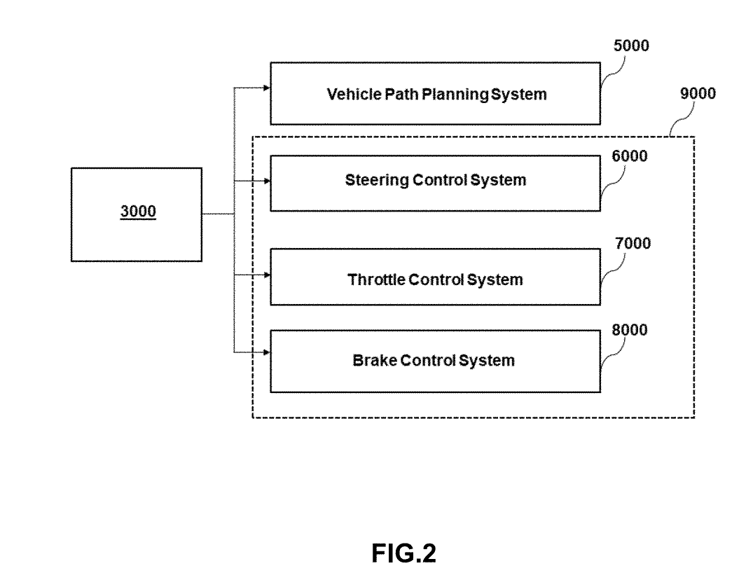

In some embodiments, pointcloud-data processor 322 would be operably connected with applications processor 324 through any type of physical interface such as interface 329. In some other embodiments, a single processing device would perform the integrated tasks of both pointcloud-data processor 322 and applications processor 324. In some embodiments, applications processor would be communicatively connected through any type of a wired connector such as connector 342 to vehicle control system interface 340. In some embodiments, applications processor 324 would relay, via vehicle control system interface 340, any of the outputs stored in memory unit 334, to a vehicle control system 9000 or to its sub systems, as shown in FIG. 2. In some embodiments, pointcloud-data processor 322 would be communicatively connected through any type of a wired connector, such as connector 352, to vehicle path planning system interface 350. In some embodiments, pointcloud-data processor 322 would relay, via vehicle path planning system interface 350, any of the stored data stored in memory unit 332, to a vehicle path planning system 5000 which is shown in FIG. 2.

In some embodiments, a single interface could replace the functions of vehicle path planning system interface 350 and vehicle control system interface 340. In some embodiments, a single memory unit could replace the functions of memory units 332, 334.

LIDAR 312 could be any type of a LIDAR scanner such as for example, LIDAR 312 could have any number of laser beams, any number of fixed or moving parts or components, any type of housing, any type of field of view either vertically or horizontally, or any type of processor as its components. In some embodiments LIDAR 312 could have a three hundred and sixty degree horizontal, field of view. In some embodiments, LIDAR 312 could have a more limited, horizontal field of view. LIDAR 312 could have any type of beam settings, in terms of laser beam emitting angle and spread, as being available or becoming available in various configurations for automotive applications related to autonomous driving. In some embodiments, LIDAR 312 could have any various additional data characteristics being available as sensor outputs, including image type representations being available, in addition to pointcloud data representation.

Stereo camera 314 could have various horizontal, baseline width measurements and could accordingly have various, suitable, depth sensing range capabilities. In some embodiments, stereo camera 314 would include; a processor, a memory and a pre-stored depth algorithm and may generate as its output, pointcloud data. In some embodiments, monocular cameras 316, 318 could be any type of monocular cameras, including machine-vision cameras, and could be configured to collectively function as a stereo rig of any suitable baseline width determination as configured. Accordingly any type of depth algorithm could be used for achieving stereo correspondence upon any monocular camera feeds being acquired from monocular cameras 316, 318. In some embodiments, any software code could be used to generate pointcloud data from a configured stereo rig comprising monocular cameras 316, 318. In some embodiments, a single monocular camera such as either 316 or 318 may be utilised, employing a monocular depth estimation algorithm to generate a pointcloud representative of the environment of an autonomous vehicle.

FIG. 2 is a block diagram of an exemplary vehicle control system 9000 comprising various vehicle control sub-systems, consistent with the disclosed embodiments. Also, an exemplary vehicle path planning system 5000 is shown, consistent with the disclosed embodiments. In some embodiments any autonomous vehicle similar to or such as autonomous vehicles 4002, 4004, 4006 or 4008, may include a steering control system 6000, a throttle control system 7000, and a brake control system 8000, as sub-systems of vehicle control system 9000. In some embodiments any autonomous vehicle similar to or such as autonomous vehicles 4002, 4004, 4006 or 4008, may include a vehicle path planning system 5000. For example, in some embodiments, system 3000 being upon autonomous vehicle 4002 may provide various types of inputs to one or more of; steering control system 6000, throttle control system 7000, brake control system 8000, and vehicle path planning system 5000 of autonomous vehicle 4002. In some embodiments, inputs provided by system 3000 to one or more of a steering control system 6000, throttle control system 7000 or brake control system 8000 of autonomous vehicle 4002, may include, any number of various types of; ground surface estimates, piece-wise linear estimates of the ground profile, smoothed ground profile estimates, ground traversability scores, piece-wise traversability scores, ground traversability maps, including various derivations and combinations thereof.

In some embodiments, the inputs provided by system 3000 to vehicle path planning system 5000 of autonomous vehicle 4002 may include any type of processed pointcloud data, including any transformed pointcloud data, or any type of segmented pointcloud data, or any other pointcloud data resulting from any processing stage of the processing tasks performed by pointcloud-data processor 322. In some embodiments, system 3000 upon autonomous vehicle 4004 would similarly provide inputs (as described above with respect to systems 5000, 6000, 7000 and 8000 of autonomous vehicle 4002), to the respective systems of autonomous vehicle 4004. In some embodiments, system 3000 upon autonomous vehicle 4006 would similarly provide inputs (as described above with respect to systems 5000, 6000, 7000 and 8000 of autonomous vehicle 4002), to the respective systems of autonomous vehicle 4006. In some embodiments, system 3000 upon autonomous vehicle 4008 would similarly provide inputs (as described above with respect to systems 5000, 6000, 7000 and 8000 of autonomous vehicle 4002), to the respective systems of autonomous vehicle 4008.

In some embodiments, inputs provided by system 3000 to one or more of a steering control system 6000, throttle control system 7000 or brake control system 8000 of autonomous vehicle 4002 for example, would be used by the vehicle control system 9000 of autonomous vehicle 4002 while determining an actuation command for the autonomous vehicle 4002. For example, while determining an actuation command pertaining to steering control system 6000, wherein the actuation command itself may be pertaining to a determination of a wheel angle sensor value of autonomous vehicle 4002, therein any of the inputs provided by system 3000 could be used by vehicle control system 9000 of autonomous vehicle 4002 while making such determination. Consistent with the exemplary disclosed embodiments, the above description would similarly apply with respect to inputs provided by system 3000 upon autonomous vehicle 4004 to steering control system 6000 of autonomous vehicle 4004, and also similarly apply to the respective cases of autonomous vehicle 4006 and autonomous vehicle 4008, as relating to their own system 3000 providing inputs to their own steering control system 6000.

Consistent with the disclosed embodiments, for example, while determining an actuation command pertaining to throttle control system 7000, wherein the actuation command itself may be pertaining to a determination of a throttle sensor position value of autonomous vehicle 4002, therein any of the inputs provided by system 3000 could be used by vehicle control system 9000 of autonomous vehicle 4002 while making such determination. Consistent with the exemplary disclosed embodiments, the above description would similarly apply with respect to inputs provided by system 3000 upon autonomous vehicle 4004 to throttle control system 7000 of autonomous vehicle 4004, and also similarly apply to the respective cases of autonomous vehicle 4006 and autonomous vehicle 4008, as relating to their own system 3000 providing inputs to their own throttle control system 7000.

Consistent with the disclosed embodiments, for example, while determining an actuation command pertaining to brake control system 8000, wherein the actuation command itself may be pertaining to a determination of a brake sensor pressure value of autonomous vehicle 4002, therein any of the inputs provided by system 3000 could be used by vehicle control system 9000 of autonomous vehicle 4002 while making such determination. Consistent with the exemplary disclosed embodiments, the above description would similarly apply with respect to inputs provided by system 3000 upon autonomous vehicle 4004 to brake control system 8000 of autonomous vehicle 4004, and also similarly apply to the respective cases of autonomous vehicle 4006 and autonomous vehicle 4008, as relating to their own system 3000 providing inputs to their own brake control system 8000.

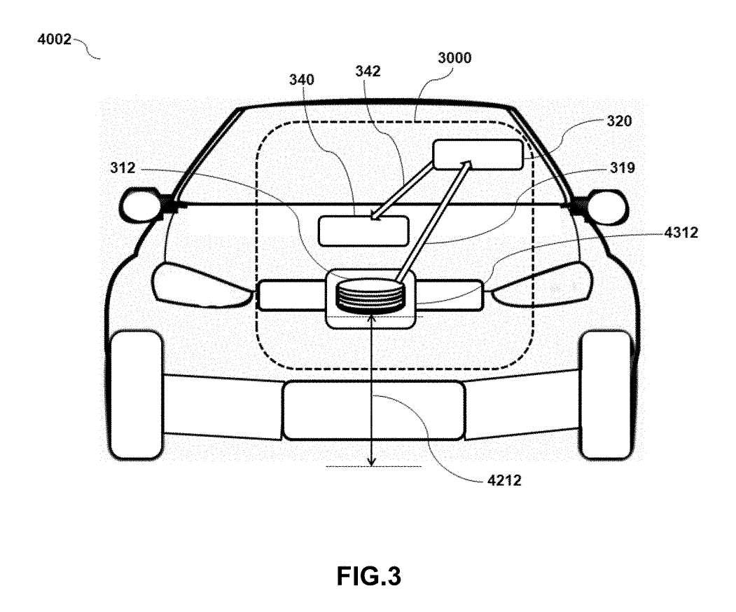

FIG. 3 is a diagrammatic front view illustration of autonomous vehicle 4002 with some components of system 3000 being representatively shown in a situational context upon autonomous vehicle 4002, consistent with the disclosed embodiments. In some embodiments a LIDAR 312 may be mounted at the front of autonomous vehicle 4002 at a height 4212 above the ground surface. In some embodiments height 4212 may be one metre. In other embodiments height 4212 may be one hundred and twenty-five centimetres. In some other embodiments, height 4212 may be one hundred and fifty centimetres. As would be apparent to one skilled in the art, height 4212 may be different according to the specific type of LIDAR 312 being employed and accordingly would be affected by the design characteristics of LIDAR 312, as well as by the operational driving domain of autonomous vehicle 4002, as being determined. In some embodiments LIDAR 312 as shown, may be mounted at the front of autonomous vehicle 4002, at height 4212 and being centred with respect to the lateral edges, for example of the vehicle body, of autonomous vehicle 4002. In some embodiments LIDAR 312 may be mounted at any roll, pitch or yaw angle as would be apparent to one skilled in the art, so as to have the optimal viewing angle. Consistent with the disclosed embodiments, LIDAR 312 is a sensor of sensing unit 310. In some embodiments, LIDAR 312 would be affixed to the body of autonomous vehicle 4002 using a mount 4312. Data interface 319 is shown to be communicatively connecting LIDAR 312 (being a sensor of sensing unit 310) to processing unit 320. In some embodiments, processing unit 320 may be situated anywhere within the trunk of autonomous vehicle 4002. In some embodiments, connector 342 may connect processing unit 320 to vehicle control system interface 340. In some embodiments vehicle control system interface 340 may be situated under the front hood of autonomous vehicle 4002.

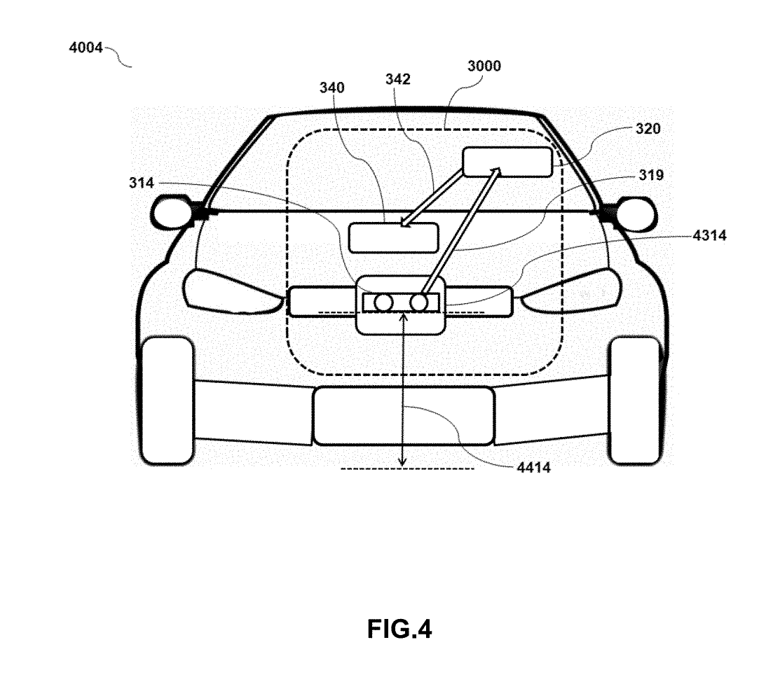

FIG. 4 is a diagrammatic front view illustration of autonomous vehicle 4004 with some components of system 3000 being representatively shown in a situational context upon autonomous vehicle 4004, consistent with the disclosed embodiments. In some embodiments a stereo camera 314 may be mounted at the front of autonomous vehicle 4004 at a height 4414 above the ground surface. In some embodiments height 4414 may be one metre. In other embodiments height 4414 may be one hundred and twenty-five centimetres. In some other embodiments, height 4414 may be one hundred and fifty centimetres. As would be apparent to one skilled in the art, height 4414 may be different according to the specific type of stereo camera 314 being employed and accordingly would be affected primarily by the design characteristics of stereo camera 314. In some embodiments stereo camera 314 as shown, may be mounted at the front of autonomous vehicle 4004, at height 4414 and being centred with respect to the lateral edges, for example of the vehicle body, of autonomous vehicle 4004. In some embodiments stereo camera 314 may be mounted at any roll, pitch or yaw angle as would be apparent to one skilled in the art, so as to have the optimal viewing angle. Consistent with the disclosed embodiments, stereo camera 314 is a sensor of sensing unit 310. In some embodiments, stereo camera 314 would be affixed to the body of autonomous vehicle 4004 using a mount 4314. Data interface 319 is shown to be communicatively connecting stereo camera 314 (being a sensor of sensing unit 310) to processing unit 320. In some embodiments, processing unit 320 may be situated anywhere within the trunk of autonomous vehicle 4004. In some embodiments, connector 342 connects processing unit 320 to vehicle control system interface 340. In some embodiments vehicle control system interface may be situated under the front hood of autonomous vehicle 4004.

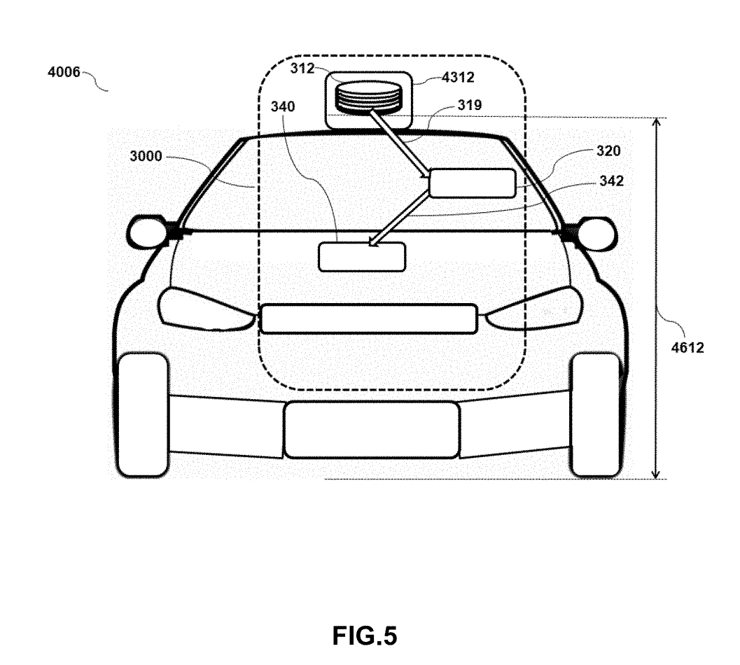

FIG. 5 is a diagrammatic front view illustration of autonomous vehicle 4006 with some components of system 3000 being representatively shown in a situational context upon autonomous vehicle 4006, consistent with the disclosed embodiments. In some embodiments a LIDAR 312 may be mounted upon the roof of the vehicle body of autonomous vehicle 4006 at a height 4612 above the ground surface. In some embodiments height 4612 may be two metres. In other embodiments height 4612 may be two hundred and twenty-five centimetres. In some other embodiments, height 4612 may be two hundred and fifty centimetres. As would be apparent to one skilled in the art, height 4612 may be different according to the specific type of LIDAR 312 being employed and accordingly would be affected by the design characteristics of LIDAR 312, as well as by the operational driving domain of autonomous vehicle 4006, as being determined. In some embodiments LIDAR 312 as shown, may be mounted upon the roof of the vehicle body of autonomous vehicle 4006, at height 4612 and being centred with respect to the lateral edges, for example of the roof of the vehicle body, of autonomous vehicle 4006. In some embodiments LIDAR 312 may be mounted at any roll, pitch or yaw angle as would be apparent to one skilled in the art, so as to have the optimal viewing angle. Consistent with the disclosed embodiments, LIDAR 312 is as a sensor of sensing unit 310. In some embodiments, LIDAR 312 would be affixed upon roof of the vehicle body of autonomous vehicle 4006 using a mount 4312. Data interface 319 is shown to be communicatively connecting LIDAR 312 (being a sensor of sensing unit 310) to processing unit 320. In some embodiments, processing unit 320 may be situated anywhere within the trunk of autonomous vehicle 4006. In some embodiments, connector 342 connects processing unit 320 to vehicle control system interface 340. In some embodiments vehicle control system interface may be situated under the front hood of autonomous vehicle 4006.

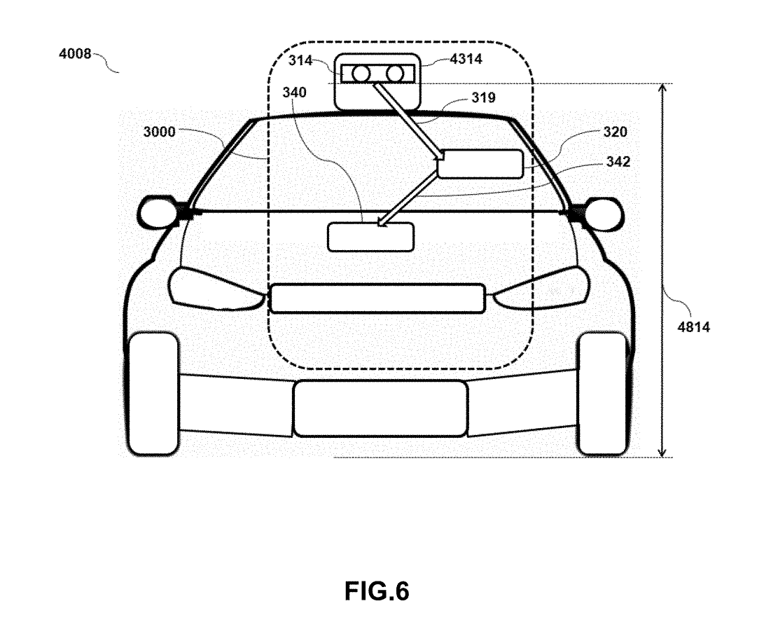

FIG. 6 is a diagrammatic front view illustration of autonomous vehicle 4008 with some components of system 3000 being representatively shown in a situational context upon autonomous vehicle 4008, consistent with the disclosed embodiments. In some embodiments a stereo camera 314 may be mounted upon the roof of the vehicle body of autonomous vehicle 4008 at a height 4814 above the ground surface. In some embodiments height 4814 may be two metres. In other embodiments height 4814 may be two hundred and twenty-five centimetres. In some other embodiments, height 4814 may be two hundred and fifty centimetres. As would be apparent to one skilled in the art, height 4814 may be different according the design characteristics of stereo camera 314, as well as by the operational driving domain of autonomous vehicle 4008, as being determined. In some embodiments stereo camera 314 as shown, may be mounted upon the roof of the vehicle body of autonomous vehicle 4008, at height 4814 and being centred with respect to the lateral edges, for example of the roof of the vehicle body, of autonomous vehicle 4008. In some embodiments stereo camera 314 may be mounted at any roll, pitch or yaw angle as would be apparent to one skilled in the art, so as to have the optimal viewing angle. Consistent with the disclosed embodiments, stereo camera 314 is as a sensor of sensing unit 310. In some embodiments, stereo camera 314 would be affixed upon the roof of the vehicle body of autonomous vehicle 4008 using a mount 4314. Data interface 319 is shown to be communicatively connecting stereo camera 314 (being a sensor of sensing unit 310) to processing unit 320. In some embodiments, processing unit 320 may be situated anywhere within the trunk of autonomous vehicle 4008. In some embodiments, connector 342 connects processing unit 320 to vehicle control system interface 340. In some embodiments vehicle control system interface may be situated under the front hood of autonomous vehicle 4008.

As would be apparent to one skilled in the art, situating LIDAR 312, as shown to be located on autonomous vehicle 4002 at the front of autonomous vehicle 4002, may yield a different usable horizontal field of view as compared to, situating LIDAR 312, as shown to be located on autonomous vehicle 4006, even if exactly the same technical design specifications of LIDAR 312 are used, in terms of horizontal field of view, in both embodiments. For example, consistent with disclosed embodiments, if LIDAR 312, with a three hundred and sixty degree horizontal field of view, is used in both embodiments (without giving regard to any difference in the vertical field of view at the moment), then, the situational context of LIDAR 312 as on autonomous vehicle 4002 would yield a more limited, usable horizontal field of view as being on autonomous vehicle 4002, as compared to a similar (in terms of horizontal field of view) LIDAR 312, as being situated on autonomous vehicle 4006. The more limited, usable horizontal field of view in the situational context of LIDAR 312 as on autonomous vehicle 4002 would in this aspect be simply due to the obstruction caused by the vehicle body of autonomous vehicle 4002. Thus the usable horizontal field of view pertaining to the situational context of LIDAR 312 as on autonomous vehicle 4002 would be primarily oriented towards a frontal region being in front of autonomous vehicle 4002. On the other hand, the situational context of a similar (in terms of horizontal field of view) LIDAR 312 as being situated on autonomous vehicle 4006, would yield a usable horizontal field of view all around (three hundred and sixty degrees around) autonomous vehicle 4006.

As would also be apparent to one skilled in the art, the situational context of an exactly same stereo camera 314, in terms of horizontal baseline width (or an exactly same stereo rig comprising monocular cameras 316, 318) being on autonomous vehicle 4004 or being on autonomous vehicle 4008, would not yield a difference in terms of usable horizontal field of view. In this aspect, in both embodiments a same stereo camera 314 would yield a usable horizontal field of view simply in accordance with its horizontal baseline width and the usable horizontal field of view would not be directly impacted by the difference in the mounting locations (in terms of horizontal field of view. Also accordingly, in this aspect, in both embodiments, the usable horizontal field of view region would be according to the forward face of stereo camera 314.

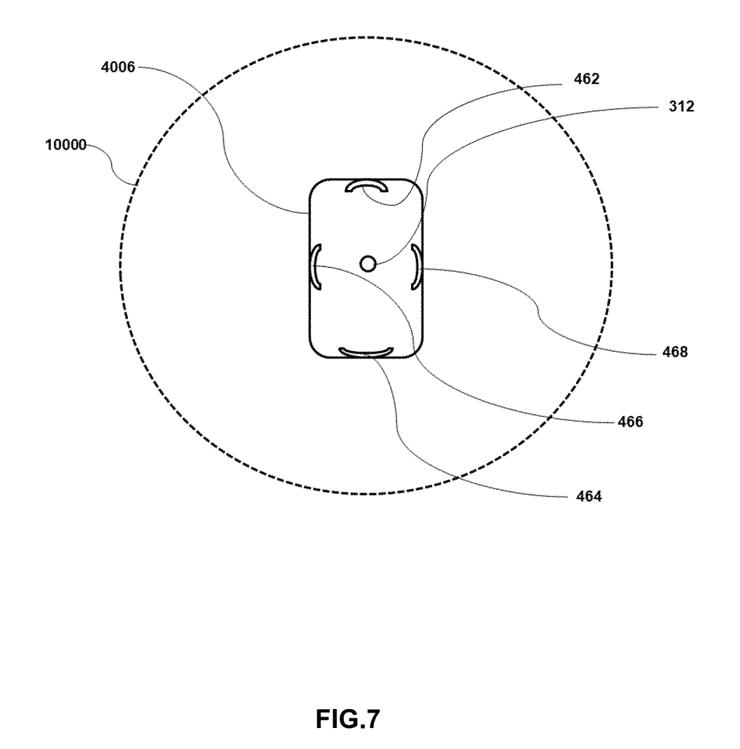

FIG. 7 is a diagrammatic representation of a potential pointcloud region 10000, shown using a top-down view, representatively showing the situational context of LIDAR 312 as on autonomous vehicle 4006, consistent with the disclosed embodiments. In some disclosed embodiments, LIDAR 312 may have a three hundred and sixty degree horizontal field of view. For example LIDAR 312 may be an HDLT™-64E by Velodyne® or may be similar to it with some variation in specifications as may be available. Accordingly LIDAR 312 may be able to spin at a rate between three hundred rotations per minute to nine hundred rotations per minute, without affecting any change in the data rate, but affecting the resolution of the data, which varies inversely with the spin rate. Thus LIDAR 312 can yield various suitable data resolutions for a full three hundred and sixty degree field of view around autonomous vehicle 4006 as situated on autonomous vehicle 4006 (and described earlier with reference to FIG. 5).

Accordingly, as shown in FIG. 7, LIDAR 312 is shown in its situational context on autonomous vehicle 4006 with a potential pointcloud region 10000 within which LIDAR 312 may yield usable (anywhere within the three hundred and sixty degree horizontal field of view), three-dimensional, pointcloud data, generated from operating LIDAR 312. In FIG. 7, a location marker 462 representatively indicates the location of a front end of the vehicle body of autonomous vehicle 4006. A location marker 464 representatively indicates the location of a rear end of the vehicle body of autonomous vehicle 4006. A location marker 466 representatively indicates the location of a lateral edge on a left side of the roof of the vehicle body of autonomous vehicle 4006. A location marker 468 representatively indicates the location of a lateral edge on a right side of the roof of the vehicle body of autonomous vehicle 4006. In some embodiments, being mounted upon the roof of the vehicle body of autonomous vehicle 4006, LIDAR 312 may be laterally centred with respect to the two locations of location markers 466, 468. In some embodiments, LIDAR 312 may additionally be centred with respect to the two locations of location markers 462, 464.

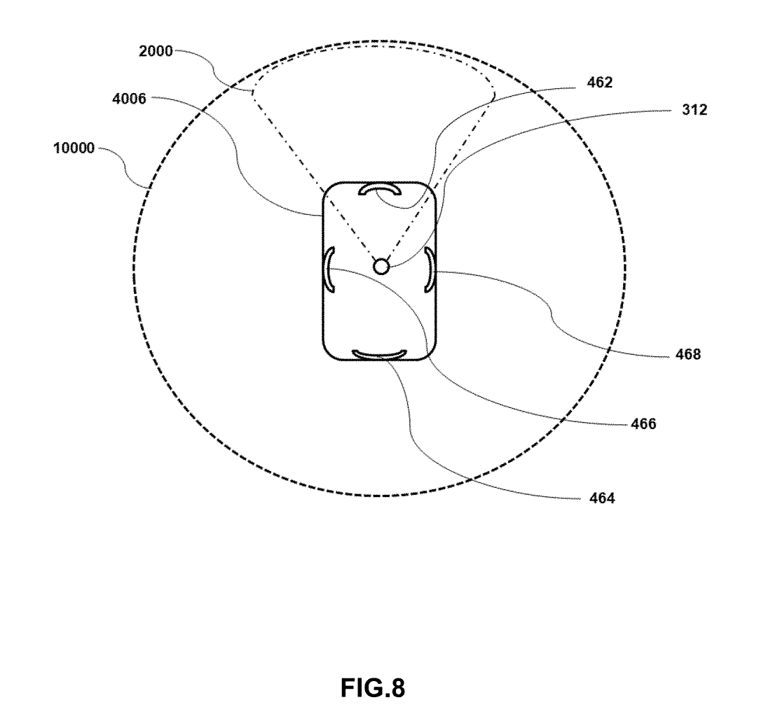

FIG. 8 shows, the same diagrammatic representation of potential pointcloud region 10000, shown using a top-down view, representatively showing the situational context of LIDAR 312 as on autonomous vehicle 4006, consistent with the disclosed embodiments, as shown earlier with reference to FIG. 7. Additionally, FIG. 8 shows, the top-down view of, a radial pointcloud 2000, oriented towards the front of autonomous vehicle 4006. In some disclosed embodiments, radial pointcloud 2000 may be determined, as shown, within potential pointcloud region 10000. In some disclosed embodiments radial pointcloud 2000 may be representative of an environment of autonomous vehicle 4006. In some embodiments, radial pointcloud 2000, may be processed by pointcloud-data processor 322, and be used for the purpose of any analysis within system 3000, for example any analysis in order to generate inputs to be used by vehicle control system 9000 of autonomous vehicle 4006 while determining an actuation command for autonomous vehicle 4006. In some disclosed embodiments, LIDAR 312 as on autonomous vehicle 4006, may be a S3™ solid state LIDAR from Quanergy® which would yield a one hundred and twenty degree horizontal field of view, which may be, as radial pointcloud 2000, as shown in FIG. 8, and be oriented towards the front of autonomous vehicle 4006. Accordingly, radial pointcloud 2000, received from any type of LIDAR 312, may be representative of an environment of autonomous vehicle 4006 and may be processed by pointcloud-data processor 322, and be used for the purpose of any analysis within system 3000, for example any analysis in order to generate inputs to be used by vehicle control system 9000 of autonomous vehicle 4006 while determining an actuation command for autonomous vehicle 4006.

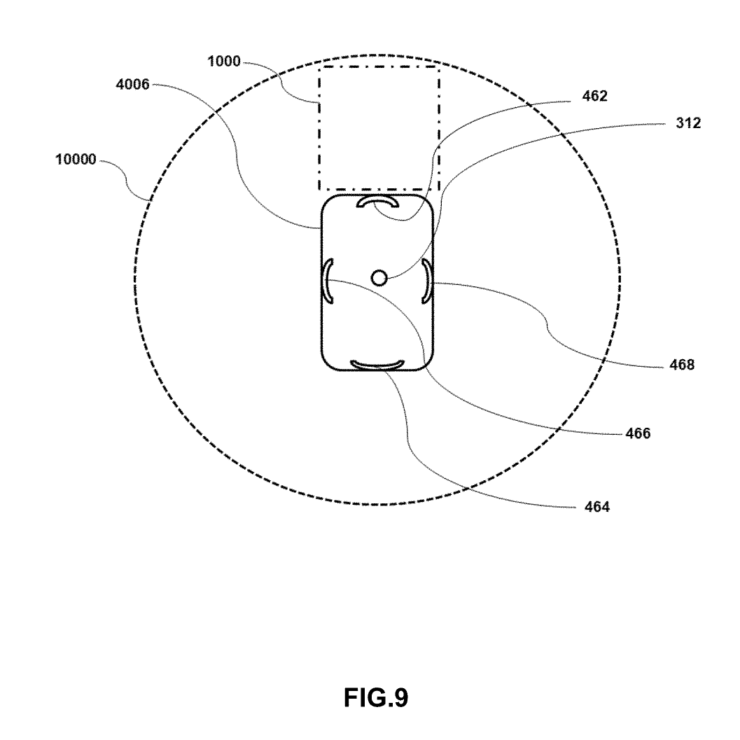

FIG. 9 shows, the same diagrammatic representation of potential pointcloud region 10000, shown using a top-down view, representatively showing the situational context of LIDAR 312 as on autonomous vehicle 4006, consistent with the disclosed embodiments, as shown earlier with reference to FIG. 7. Additionally, FIG. 9 shows, the top-down view of, a cuboid pointcloud 1000 oriented towards the front of autonomous vehicle 4006. In some disclosed embodiments, cuboid pointcloud 1000 may be determined, as shown, within potential pointcloud region 10000. In some disclosed embodiments cuboid pointcloud 1000 may be representative of an environment of autonomous vehicle 4006. In some embodiments, cuboid pointcloud 1000, may be processed by pointcloud-data processor 322, and be used for the purpose of any analysis within system 3000. Consistent with the disclosed embodiments, cuboid pointcloud 1000, received from any type of LIDAR 312 (and, whether having, a full three hundred and sixty degree horizontal field of view, a one hundred and twenty degree horizontal field of view, or any other horizontal field of view), may be representative of an environment of autonomous vehicle 4006 and may be processed by pointcloud-data processor 322, and be used for the purpose of any analysis within system 3000, for example any analysis in order to generate inputs to be used by vehicle control system 9000 of autonomous vehicle 4006 while determining an actuation command for autonomous vehicle 4006.

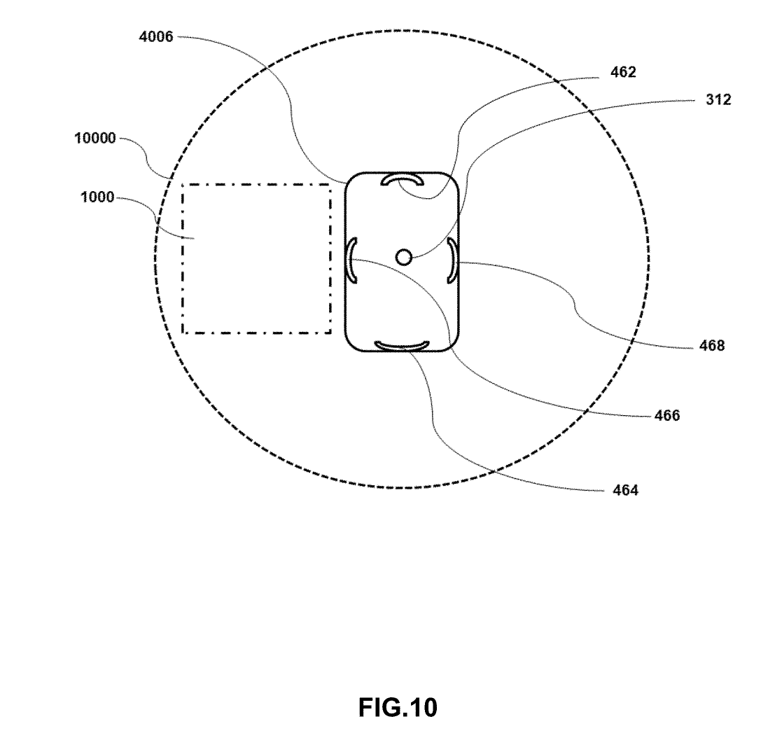

FIG. 10 shows, the same diagrammatic representation of potential pointcloud region 10000, shown using a top-down view, representatively showing the situational context of LIDAR 312 as on autonomous vehicle 4006, consistent with the disclosed embodiments, as shown earlier with reference to FIG. 7. Additionally, FIG. 10 shows, the top-down view of, a cuboid pointcloud 1000 oriented towards the left side (the left side as indicated by the location of the location marker 466) of autonomous vehicle 4006. In some disclosed embodiments, cuboid pointcloud 1000 may be determined, as shown, within potential pointcloud region 10000. In some disclosed embodiments cuboid pointcloud 1000 may be representative of an environment of autonomous vehicle 4006. In some embodiments, cuboid pointcloud 1000 (being oriented as shown in FIG. 10) may be processed by pointcloud-data processor 322, and be used for the purpose of any analysis within system 3000. Consistent with the disclosed embodiments, cuboid pointcloud 1000, received from any type of LIDAR 312 (and, whether having, a full three hundred and sixty degree horizontal field of view, a one hundred and twenty degree horizontal field of view, or any other horizontal field of view), may be representative of an environment of autonomous vehicle 4006 and accordingly may be processed by pointcloud-data processor 322, and be used for the purpose of any analysis within system 3000, for example any analysis in order to generate inputs to be used by vehicle control system 9000 of autonomous vehicle 4006 while determining an actuation command for autonomous vehicle 4006.

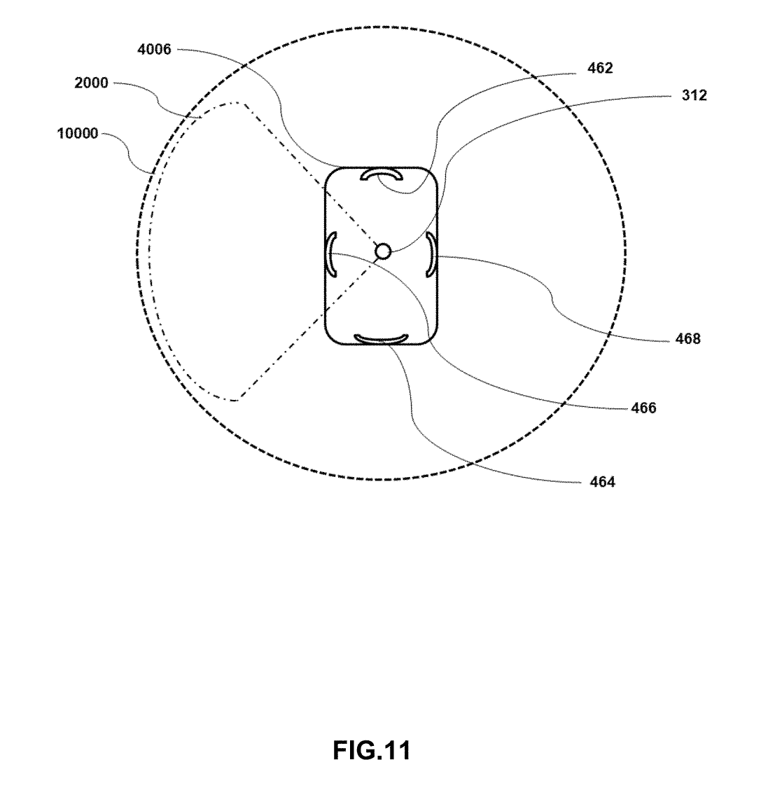

FIG. 11 shows, the same diagrammatic representation of a potential pointcloud region 10000, shown using a top-down view, representatively showing the situational context of LIDAR 312 as on autonomous vehicle 4006, consistent with the disclosed embodiments, as shown earlier with reference to FIG. 7. Additionally, FIG. 11 shows, the top-down view of, a radial pointcloud 2000 oriented towards the left side (the left side as indicated by the location of the location marker 466) of autonomous vehicle 4006. In some disclosed embodiments, radial pointcloud 2000 may be determined, as shown, within potential pointcloud region 10000. In some disclosed embodiments radial pointcloud 2000 may be representative of an environment of autonomous vehicle 4006. In some embodiments, radial pointcloud 2000 (being oriented as shown in FIG. 11) may be processed by pointcloud-data processor 322, and be used for the purpose of any analysis within system 3000. Consistent with the disclosed embodiments, radial pointcloud 2000, received from any type of LIDAR 312 (and, whether having, a full three hundred and sixty degree horizontal field of view, a one hundred and twenty degree horizontal field of view, or any other horizontal field of view), may be representative of an environment of autonomous vehicle 4006 and accordingly may be processed by pointcloud-data processor 322, and be used for the purpose of any analysis within system 3000, for example any analysis in order to generate inputs to be used by vehicle control system 9000 of autonomous vehicle 4006 while determining an actuation command for autonomous vehicle 4006.

Consistent with the disclosed embodiments, cuboid pointcloud 1000, or radial pointcloud 2000, either being in any orientation with respect to any location on autonomous vehicle, either received from any type of LIDAR 312, may be representative of an environment of autonomous vehicle 4006 and accordingly, either may be processed within any part of system 3000, such as for example by pointcloud-data processor 322, and be transmitted to vehicle path planning system 5000 of autonomous vehicle 4006. Consistent with the disclosed embodiments, cuboid pointcloud 1000, or radial pointcloud 2000, either being in any orientation with respect to any location on autonomous vehicle 4006, received from any type of LIDAR 312, may be representative of an environment of autonomous vehicle 4006 and accordingly, either may be processed within any part of system 3000, such as for example by pointcloud-data processor 322, and application processor 324, and therein perform any analysis, for example, in order to, provide inputs to vehicle control system 9000 of autonomous vehicle 4006 while determining an actuation command for autonomous vehicle 4006.

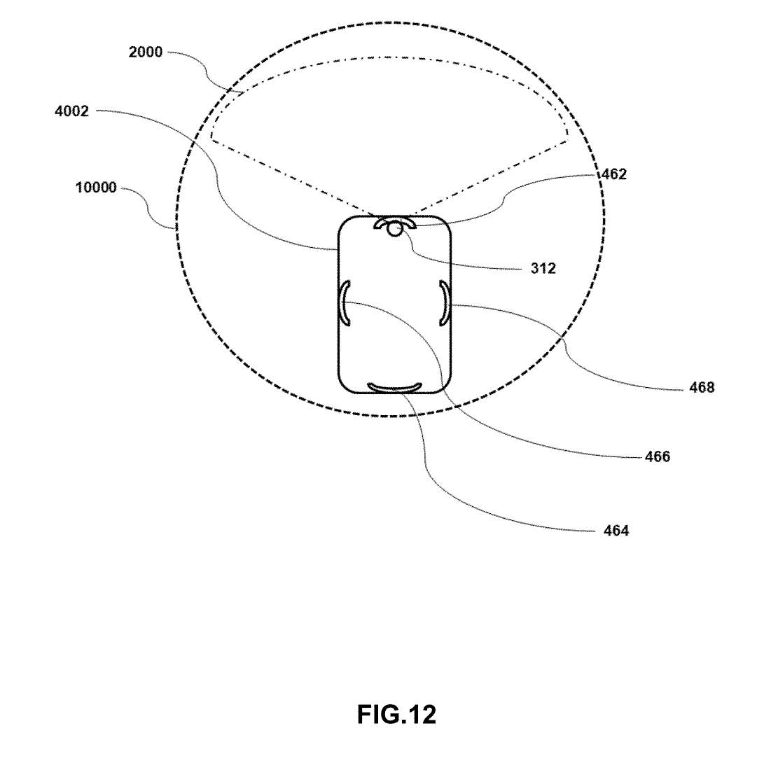

FIG. 12 is a diagrammatic representation of potential pointcloud region 10000, shown using a top-down view, representatively showing the situational context of LIDAR 312 as on autonomous vehicle 4002, consistent with the disclosed embodiments. LIDAR 312 is shown in its situational context on autonomous vehicle 4002 with a potential pointcloud region 10000 within which LIDAR 312 may yield usable (anywhere within the three hundred and sixty degree horizontal field of view), three-dimensional, pointcloud data, generated from operating LIDAR 312. In FIG. 12, a location marker 462 representatively indicates the location of a front end of the vehicle body of autonomous vehicle 4002. A location marker 464 representatively indicates the location of a rear end of the vehicle body of autonomous vehicle 4002. A location marker 466 representatively indicates the location of a lateral edge on a left side of the roof of the vehicle body of autonomous vehicle 4002. A location marker 468 representatively indicates the location of a lateral edge on a right side of the roof of the vehicle body of autonomous vehicle 4002. In some embodiments, being mounted at the front of the vehicle body of autonomous vehicle 4002 (as explained earlier with reference to FIG. 3), LIDAR 312 may be laterally centred with respect to the two locations of location markers 466, 468. FIG. 12 also shows, the top-down view of, a radial pointcloud 2000, being oriented towards the front of autonomous vehicle 4002. Radial pointcloud 2000, may be acquired by any type of LIDAR 312, wherein, LIDAR 312, may be as shown in its situational context upon autonomous vehicle 4002, and, radial pointcloud 2000 (as shown in FIG. 12) may be representative of an environment of autonomous vehicle 4002. In some embodiments, radial pointcloud 2000, may be, processed through various disclosed methods by pointcloud-data processor 322 and/or analysed through various disclosed methods by application processor 324 and accordingly, be used for any purpose of, system 3000 of autonomous vehicle 4002.

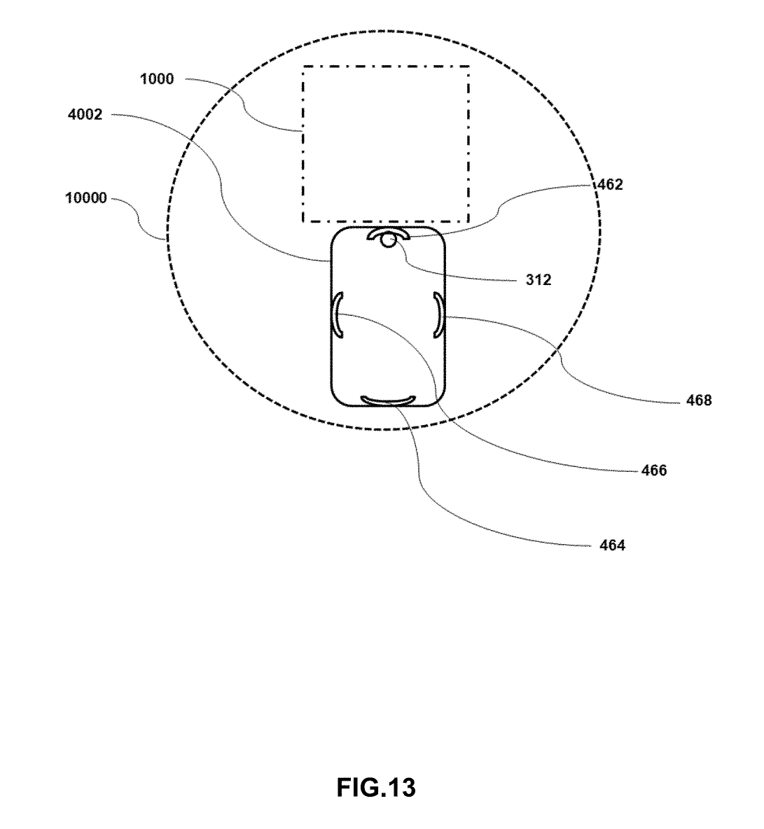

FIG. 13 shows, the same diagrammatic representation of a potential pointcloud region 10000, shown using a top-down view, representatively showing the situational context of LIDAR 312 as on autonomous vehicle 4002, consistent with the disclosed embodiments, as shown earlier with reference to FIG. 12. In FIG. 13 (instead of radial pointcloud 2000 that was shown in FIG. 12), a top-down view of, a cuboid pointcloud 1000, being oriented towards the front of autonomous vehicle 4002, is shown. Cuboid pointcloud 1000 may be acquired by any type of LIDAR 312, wherein, LIDAR 312, may be on autonomous vehicle 4002 (being mounted at the front of the vehicle body of autonomous vehicle 4002 as explained earlier with reference to FIG. 3). In accordance with the disclosed embodiments, cuboid pointcloud 1000 (as shown in FIG. 13) may be representative of an environment of autonomous vehicle 4002. In some embodiments, cuboid pointcloud 1000, may be, processed through various disclosed methods by pointcloud-data processor 322 and/or analysed through various disclosed methods by application processor 324 and accordingly, be used for any purpose of, system 3000 of autonomous vehicle 4002.

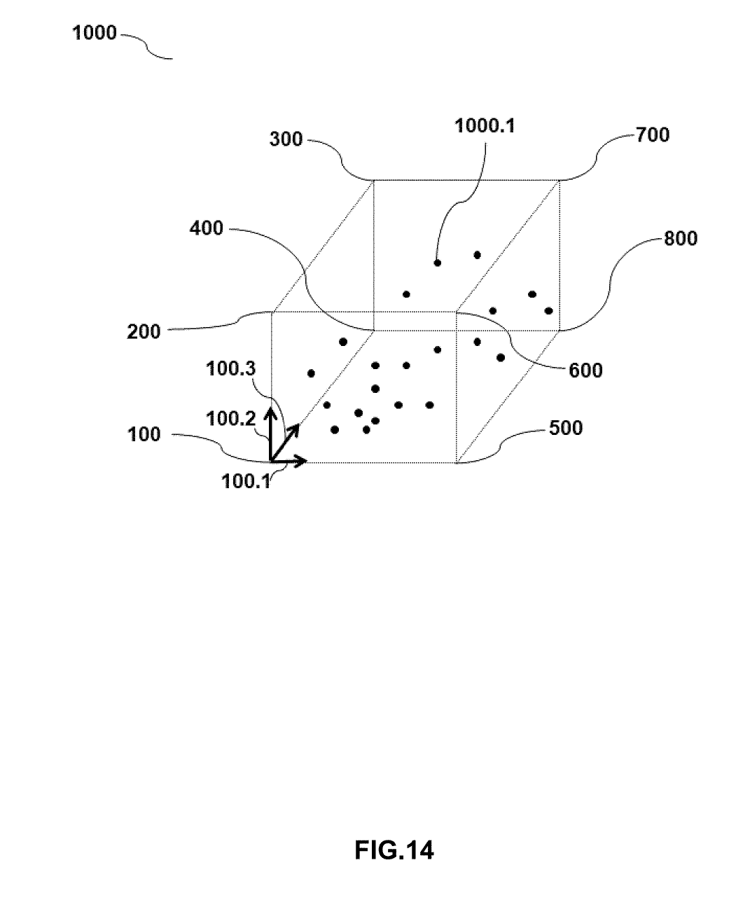

FIG. 14 is a diagrammatic, three-dimensional representation of a cuboid pointcloud 1000, consistent with the disclosed embodiments. A cuboid pointcloud 1000 is shown in FIG. 14. A pointcloud data point 1000.1 is shown within cuboid pointcloud 1000. The three-dimensional location of, a pointcloud data point such as pointcloud data point 1000.1, as within cuboid pointcloud 1000, can be ascertained by knowing the distance of pointcloud data point 1000.1 along dimensions 100.1, 100.2, and 100.3. A point of origin 100, may serve as a point of origin, for the distance value along any of the dimensions 100.1, 100.2, and 100.3. Point of origin 100 may also serve as a corner reference for cuboid pointcloud 1000. Corner references 200, 300, 400, 500, 600, 700, and 800, along with the point of origin 100 serving as a corner reference, may be used to reference the location of various corners of cuboid pointcloud 1000. Consistent with the various disclosed embodiments, as shown in any top-down view of cuboid pointcloud 1000 (for example as shown in FIG. 9, FIG. 10, and FIG. 13), a point of origin 100 may correspond to (i.e. correspond by being situated vertically below) any one of, the four corners of cuboid pointcloud 1000 as visible in any shown top-down view of cuboid pointcloud 1000 (as shown e.g. in FIG. 9, FIG. 10, and FIG. 13), as determined differently in various different embodiments.

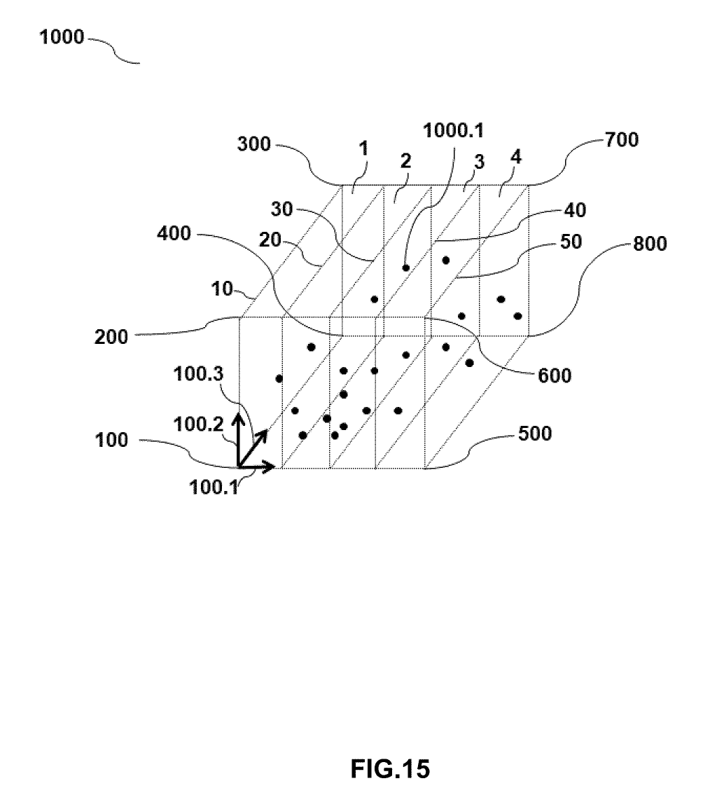

FIG. 15 shows the same diagrammatic, three-dimensional representation of a cuboid pointcloud 1000, consistent with the disclosed embodiments, shown earlier in FIG. 14. Additionally, FIG. 15 shows segments 1, 2, 3 and 4. In accordance with the disclosed embodiments, any pointcloud data point of cuboid pointcloud 1000 may be allocated as belonging within a particular segment. For example, pointcloud data point 1000.1 may be one of the pointcloud data points to be allocated as belonging within segment 3, as shown in FIG. 15. In accordance with the disclosed embodiments, segments 1, 2, 3 and 4 may be determined as being contiguous, parallel segments within cuboid pointcloud 1000. FIG. 15 also additionally shows virtual planes 10, 20, 30, 40 and 50. Consistent with the disclosed embodiments, virtual planes 10, 20, 30, 40 and 50 may all be parallel to each other. As shown in FIG. 15, segment 1 is bounded within virtual plane 10 and virtual plane 20. Segment 2, as shown is bounded within virtual plane 20 and virtual plane 30. Segment 3, as shown is bounded within virtual plane 30 and virtual plane 40. Segment 4, as shown is bounded within virtual plane 40 and virtual plane 50. In various embodiments, larger or smaller number of total segments may be determined with respect to cuboid pointcloud 1000, based on the data resolution level of the LIDAR 312 generating the pointcloud. A more dense data resolution level may permit a higher number of total segments.

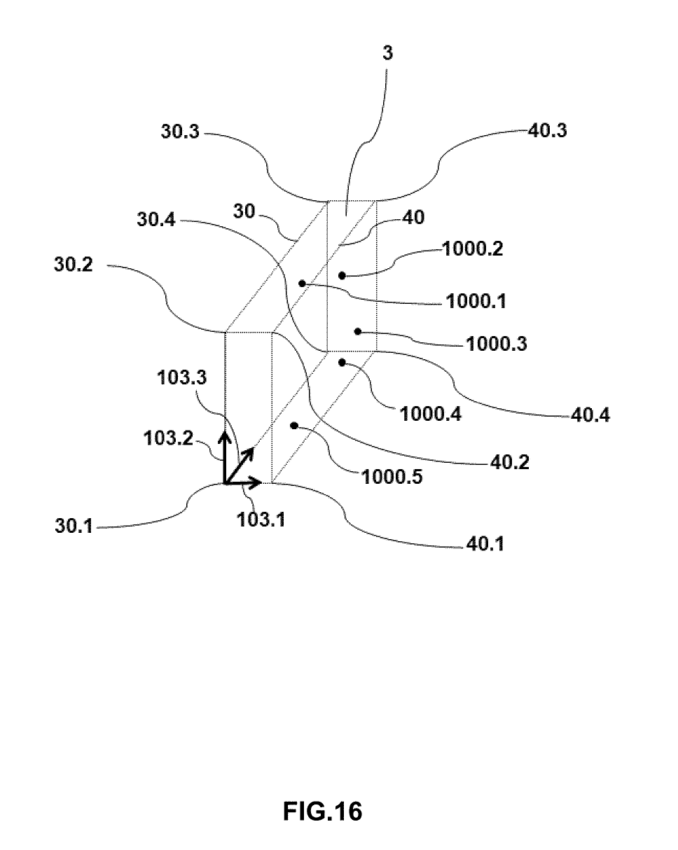

FIG. 16 is a diagrammatic, three-dimensional representation of segment 3 of cuboid pointcloud 1000, consistent with the disclosed embodiments. In accordance with the disclosed embodiments, segment 3 is bounded within virtual plane 30 and virtual plane 40. The three-dimensional location of, a pointcloud data point such as pointcloud data point 1000.1, as within segment 3, can be ascertained by knowing the distance of pointcloud data point 1000.1 along dimensions 103.1, 103.2, and 103.3. A point of origin 30.1, may serve as a point of origin, for the distance value along any of the dimensions 103.1, 103.2, and 103.3. Point of origin 30.1 may also serve as a corner reference for segment 3. Corner references 30.2, 30.3, 30.4, 40.1, 40.2, 40.3, and 40.4, along with the point of origin 30.1 serving as a corner reference, may be used to reference the location of various corners of segment 3. Consistent with the disclosed embodiments, pointcloud data points 1000.1, 1000.2, 1000.3, 1000.4, and 1000.5 are shown to be all of the pointcloud data points allocated as belonging within segment 3. In some embodiments, the allocation of these specific pointcloud data points to this particular segment, i.e. segment 3, would be due to and in accordance with, the situational context of these specific pointcloud data points, while being within cuboid pointcloud 1000, also being within, the determined boundaries of this particular segment, i.e. within the determined boundaries of segment 3 (the determined boundaries as being given by virtual plane 30 and virtual plane 40).

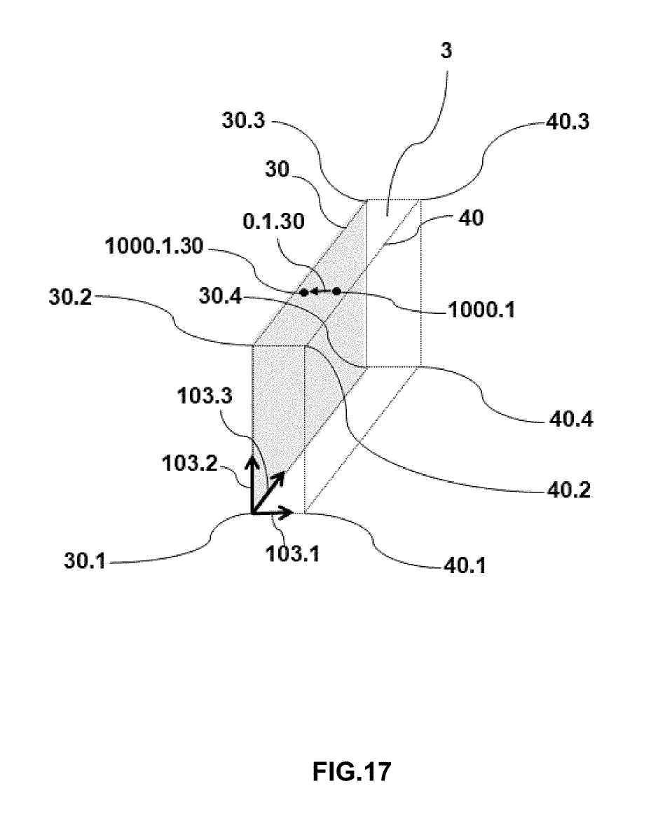

FIG. 17 shows the same diagrammatic, three-dimensional representation of segment 3 of cuboid pointcloud 1000, consistent with the disclosed embodiments, as was shown with reference to FIG. 16, however in FIG. 17 only pointcloud data point 1000.1, is shown in order to illustrate by its example how any pointcloud data point of cuboid pointcloud 1000, that has been allocated as belonging within a particular segment, such as within segment 3 for example, may be transformed on to a virtual plane, such as virtual plane 30 for example, in this case. In some embodiments, as shown in FIG. 17, pointcloud data point 1000.1 may be transformed on to virtual plane 30, through an orthogonal vector 0.1.30. In accordance with the disclosed embodiments, transformation of pointcloud data point 1000.1 along orthogonal vector 0.1.30, extends all the way to the boundary of segment 3 as being given by virtual plane 30, and results in the three dimensional, location characteristics of pointcloud data point 1000.1 being transformed to two dimensional location characteristics, by being transformed on to virtual plane 30. Accordingly, after being transformed by orthographic projection, through orthogonal vector 0.1.30, a transformed, pointcloud data point 1000.1.30 is shown on virtual plane 30. In some embodiments, any pointcloud data point such as pointcloud data point 1000.1 of cuboid pointcloud 1000, having been allocated as belonging within segment 3, may be transformed on to virtual plane 30. Consistent with some disclosed embodiments, this transformation may be achieved by orthographic projection, along an orthogonal vector. In some other embodiments, this transformation may be achieved along any other angular vector being of any suitably determined angle. In some disclosed embodiments, after transformation through orthogonal vector 0.1.30, transformed, pointcloud data point 1000.1.30 would retain the original location characteristics of pointcloud data point 1000.1 as within segment 3 along dimensions 103.2 and 103.3 (of segment 3), while relinquishing the precise location of 1000.1 as within segment 3 along dimension 103.1 (of segment 3). Accordingly, after transformation through orthogonal vector 0.1.30, transformed, pointcloud data point 1000.1.30 would retain the original location characteristics of pointcloud data point 1000.1 as within cuboid pointcloud 1000 along dimensions 100.2 and 100.3 (of cuboid pointcloud 1000), while relinquishing the precise location of 1000.1 as within segment 3 along dimension 103.1 (of cuboid pointcloud 1000).

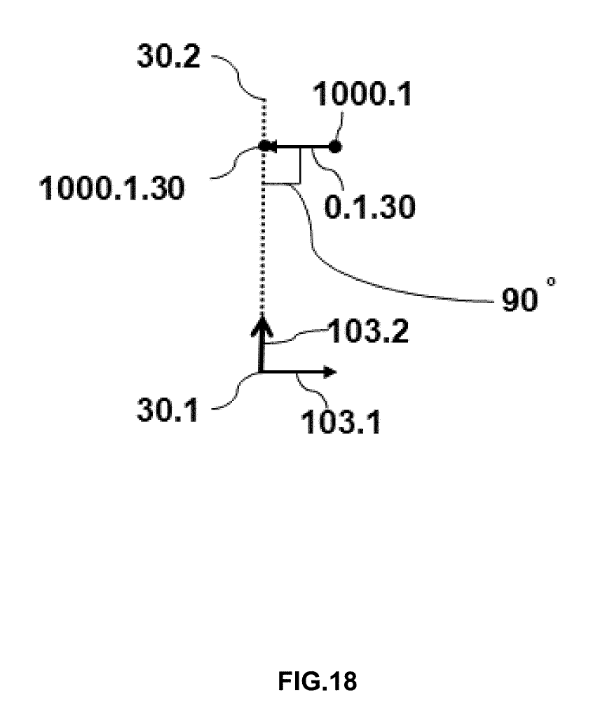

FIG. 18 is a diagrammatic representation of a side-edge view of virtual plane 30, consistent with the disclosed embodiments, wherein a side edge of virtual plane 30 is shown, as between corner references 30.1 and 30.2. Orthogonal vector 0.1.30 is also shown, and is shown to be having an angle of 90° with respect, to virtual plane 30 and the original location of pointcloud data point 1000.1. As shown in FIG. 18, pointcloud data point 1000.1 is represented, as being in its original position within segment 3. Consistent with the disclosed embodiments, transformed, pointcloud data point 1000.1.30 is shown on virtual plane 30. Accordingly, as shown, the location of transformed, pointcloud data point along dimension 103.2 (of segment 3) remains the same as, the location of pointcloud data point 1000.1 originally, along dimension 103.2 as being within segment 3. However, it can be seen that the precise location of pointcloud data point 1000.1 along dimension 103.1 (of segment 3) is no longer available in transformed, pointcloud data point 1000.1.30 (having been relinquished due to the transformation).

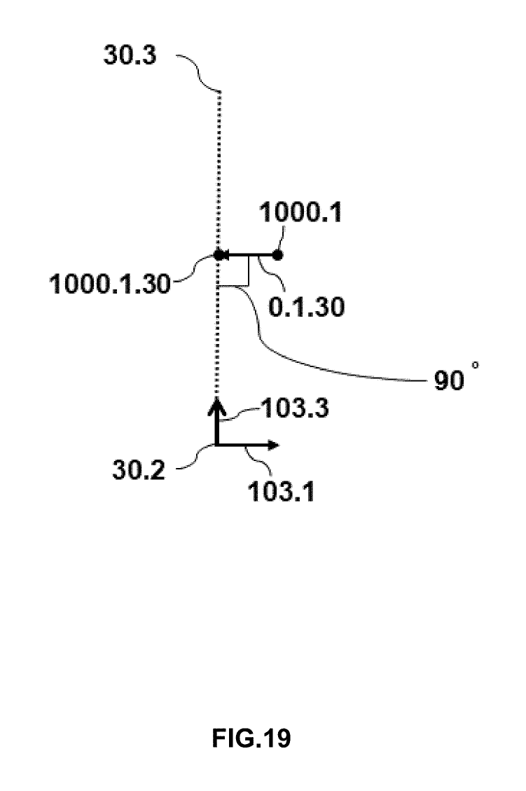

FIG. 19 is a diagrammatic representation of a top-edge view of virtual plane 30, consistent with the disclosed embodiments, wherein a top-edge of virtual plane 30 is shown, as between corner references 30.2 and 30.3. The same orthogonal vector 0.1.30, as shown in FIG. 18, is also shown, and orthogonal vector 0.1.30 is shown to be having an angle of 90° with respect, to virtual plane 30 and the original location of pointcloud data point 1000.1. As shown in FIG. 19, pointcloud data point 1000.1 is represented, as being in its original position within segment 3. Consistent with the disclosed embodiments, transformed, pointcloud data point 1000.1.30 is shown on virtual plane 30. Accordingly, as shown, the location of transformed, pointcloud data point along dimension 103.3 (of segment 3) remains the same as, the location of pointcloud data point 1000.1 originally, along dimension 103.3 as being within segment 3. However, it can be seen that the precise location of pointcloud data point 1000.1 along dimension 103.1 (of segment 3) is no longer available in transformed, pointcloud data point 1000.1.30 (having been relinquished due to the transformation).

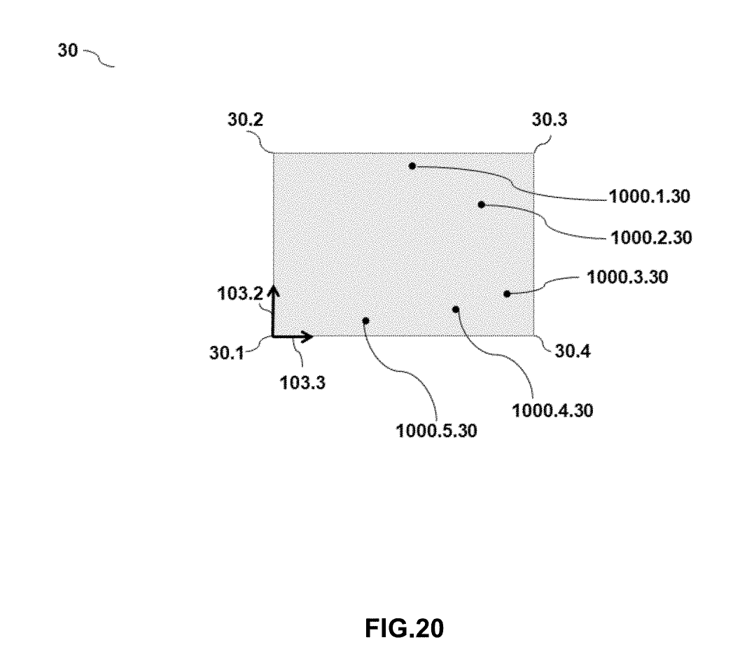

FIG. 20 is a diagrammatic, representation of a full planar view of virtual plane 30, consistent with the disclosed embodiments. Similar to the example as described with reference to pointcloud data point 1000.1, therein describing with reference to FIG. 17, FIG. 18 and FIG. 19, how pointcloud data point 1000.1 may be transformed on to virtual plane 30, accordingly, pointcloud data points 1000.2, 1000.3, 1000.4 and 1000.5 as shown in FIG. 16, and having been allocated also as belonging within segment 3, may also similarly, be transformed on to virtual plane 30. Thus accordingly, and respectively, transformed, pointcloud data points 1000.2.30, 1000.3.30, 1000.4.30 and 1000.5.30 are shown as having been transformed on to virtual plane 30, in FIG. 20, and transformed, pointcloud data point 1000.1.30 is also shown as having been transformed on to virtual plane 30. In accordance with the disclosed embodiments, the location of each of the transformed, pointcloud data points; 1000.1.30, 1000.2.30, 1000.3.30, 1000.4.30 and 1000.5.30, upon virtual plane 30, can be referenced with respect to dimensions 103.2 and 103.3 of virtual plane 30 (herein to be noted that dimensions 103.2 and 103.3 are two of the three dimensions of segment 3 as well). Corner references 30.1, 30.2, 30.3 and 30.4, may be used to reference the four corners of virtual plane 30 and herein corner reference 30.1 may be used as a point of origin for location measurements upon virtual plane 30, of any transformed, pointcloud data points, along dimensions 103.2 and 103.3 of virtual plane 30.

As would be apparent to one skilled in the art, various types of different LIDARs would generate various types of different data resolutions, being expressed in an aspect, in terms of the total number of pointcloud data points being generated per second by the LIDAR. For example, when using an HDL™-64E by Velodyne® as LIDAR 312 in system 3000, according to the current technical specifications of HDL™-64E by Velodyne®, over two million pointcloud data points would be generated per second and accordingly, a substantial number of these (over two million pointcloud data points) would be part of cuboid pointcloud 1000. In some embodiments, LIDAR 312 on autonomous vehicle 4002 or autonomous vehicle 4006, may be a VLS-128™ LIDAR by Velodyne®. For example, when using a VLS-128™ LIDAR by Velodyne® as LIDAR 312 in system 3000, according to the technical specifications VLS-128™ LIDAR by Velodyne®, over nine million pointcloud data points would be generated per second and accordingly, a substantial number of these (over nine million pointcloud data points) would be part of cuboid pointcloud 1000. Also accordingly, in some embodiments, when using any type of high resolution LIDAR (as a LIDAR 312) in sensing unit 310, would result in there being thousands of pointcloud data points even within a segment of a pointcloud, such as for example, it may result in there being thousands of pointcloud data points within segment 3 of cuboid pointcloud 1000. As would be apparent to one skilled in the art, the structure of the environment itself, i.e. the environment being represented by LIDAR 312 through the pointcloud data points, would also impact the total number of pointcloud data points resulting within cuboid pointcloud 1000 and accordingly resulting within a particular segment, such as for example within segment 3.

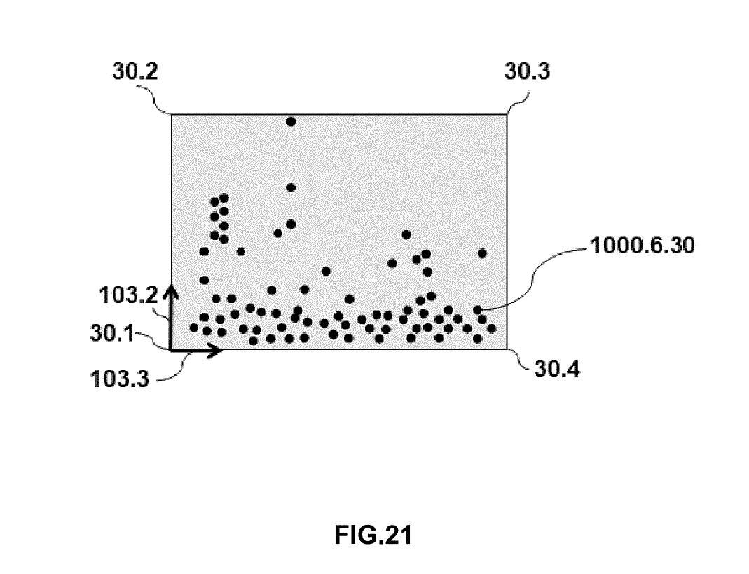

FIG. 21 is a diagrammatic representation of a full planar view, of virtual plane 30, consistent with the disclosed embodiments, if cuboid pointcloud 1000 were acquired using a higher resolution LIDAR being used as LIDAR 312, as compared to, earlier shown examples of cuboid pointcloud 1000, the difference herein being in terms of the resulting total number of pointcloud data points in cuboid pointcloud 1000. Accordingly there would result, a higher total number pointcloud data points allocated as belonging within a particular segment, such as segment 3, for example, and also accordingly, there would result, consistent with the disclosed embodiments, a higher total number of transformed, pointcloud data points being upon virtual plane 30. In FIG. 21, a transformed, pointcloud data point 1000.6.30 is shown as being labelled, on virtual plane 30. As would be apparent to one skilled in the art, pointcloud data processor 322 may perform any type of ‘sensor noise’ removal step, to eliminate any pointcloud data points that may be deemed to be due to ‘sensor noise’, when processing any pointcloud such as for example when processing, cuboid pointcloud 1000, and this may result in elimination of some pointcloud data points from the analysis on account of being classified as sensor noise within cuboid pointcloud 1000. As shown in FIG. 21, corner references 30.1, 30.2, 30.3 and 30.4, may be used to reference the four corners of virtual plane 30 and herein corner reference 30.1 may be used as a point of origin for location measurements upon virtual plane 30, of any transformed, pointcloud data point, along dimensions 103.2 and 103.3 of virtual plane 30.

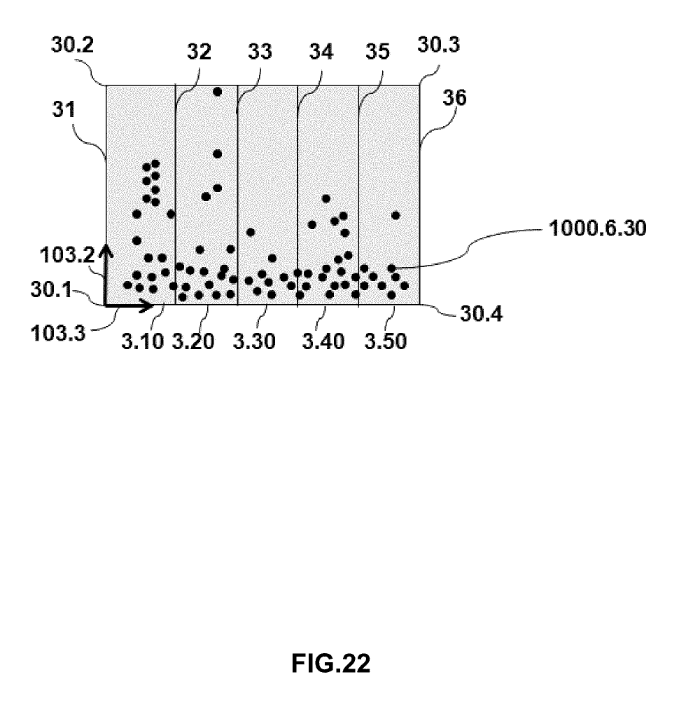

FIG. 22 is a diagrammatic representation of a full planar view, of virtual plane 30, which was also shown in FIG. 21. Consistent with the disclosed embodiments, as shown in FIG. 22, virtual plane 30 has been sectioned into a sequence of depth sections 3.10, 3.20, 3.30, 3.40, and 3.50. The top edge of virtual plane 30 may be referenced by line segment lying between corner references 30.2 and 30.3. The bottom edge of virtual plane 30 may be referenced by line segment lying between corner references 30.1 and 30.4. Accordingly, in some embodiments, each depth section from the sequence of depth sections 3.10, 3.20, 3.30, 3.40, and 3.50, may be bounded at its top edge by line segment lying between corner references 30.2 and 30.3 and may be bounded at its bottom edge by line segment lying between corner references 30.1 and 30.4. In some embodiments, each depth section from the sequence of depth sections 3.10, 3.20, 3.30, 3.40, and 3.50, may each be bounded by two side edge lines. Side edge lines 31 and 32 are the two side edge lines for depth section 3.10, and herein depth section 3.10 may be determined as a first depth section in the sequence of depth sections on virtual plane 30, with side edge line 31 representing the beginning (while moving left to right in FIG. 22, i.e. moving from corner reference 30.1, along dimension 103.3 towards corner reference 30.4) of depth section 3.10 and side edge line 32 representing the end of depth section 3.10. Consistent with the disclosed embodiments, depth section 3.20 may be determined as a second depth section in the sequence of depth sections on virtual plane 30, with side edge line 32 representing the beginning of depth section 3.20 and side edge line 33 representing the end of depth section 3.20. Accordingly, depth section 3.30 may be determined as a third depth section in the sequence of depth sections on virtual plane 30, with side edge line 33 representing the beginning of depth section 3.30 and side edge line 34 representing the end of depth section 3.30. Also accordingly, depth section 3.40 may be determined as a fourth depth section in the sequence of depth sections on virtual plane 30, with side edge line 34 representing the beginning of depth section 3.40 and side edge line 35 representing the end of depth section 3.40. Lastly, and also accordingly, depth section 3.50 may be determined as a fifth depth section in the sequence of depth sections on virtual plane 30, with side edge line 35 representing the beginning of depth section 3.50 and side edge line 36 representing the end of depth section 3.50. As seen in FIG. 22, transformed, pointcloud data point 1000.6.30 is shown as upon depth section 3.50.

Consistent with the disclosed embodiments, application processor 324 may analyse, a plurality of depth sections to determine correspondingly a plurality of piece-wise linear estimates of the ground profile of various parts of the ground surface (the ground surface being part of the environment of autonomous vehicle 4002 or autonomous vehicle 4006 as being represented within cuboid pointcloud 1000). In some embodiments, analysing, a plurality of depth sections to determine correspondingly a plurality of piece-wise linear estimates of the ground profile of various parts of the ground surface may be through performing a sequential analysis of each of depth sections 3.10, 3.20, 3.30, 3.40, and 3.50. Consistent with the disclosed embodiments, application processor 324 may use any of the outputs of a sequential analysis of each of depth sections 3.10, 3.20, 3.30, 3.40, and 3.50 in order to, calculate a ground surface estimate by combining, any number of piece-wise linear estimates from among the plurality of piece-wise linear estimates of the ground profile (with respect to the ground surface as being represented within any segment of cuboid pointcloud 1000, for example as being represented within segment 3 of cuboid pointcloud 1000).

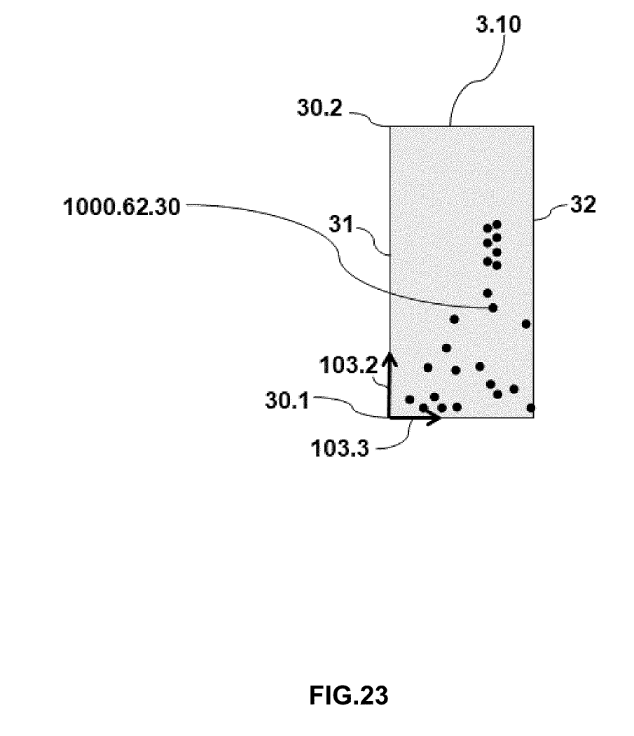

FIG. 23 is a diagrammatic representation providing a more detailed view of depth section 3.10, consistent with the disclosed embodiments, and therein also showing, a transformed, pointcloud data point 1000.62.30, as upon depth section 3.10. Side edge lines 31 and 32, shown in FIG. 23, as well as corner references 30.1 and 30.2, and dimensions 103.2 and 103.3, are as shown and described in reference in FIG. 22.

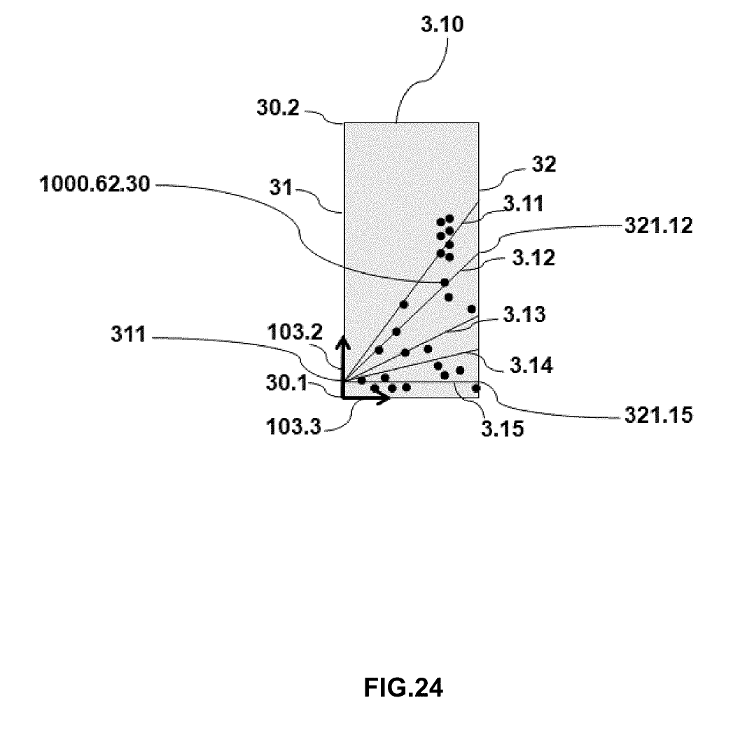

FIG. 24 is a diagrammatic representation of the same, detailed view of depth section 3.10, as shown with reference to FIG. 23, consistent with the disclosed embodiments. Additionally, FIG. 24 shows a set of candidate line segments 3.11, 3.12, 3.13, 3.14 and 3.15 upon depth section 3.10. In some embodiments, each of candidate line segments 3.11, 3.12, 3.13, 3.14 and 3.15 upon depth section 3.10, would have a common, beginning-point-of-origin 311. Accordingly, in some embodiments, as shown in FIG. 24, all candidate line segments 3.11, 3.12, 3.13, 3.14 and 3.15 commence at beginning-point-of-origin 311, while each candidate line segment from among candidate line segments 3.11, 3.12, 3.13, 3.14 and 3.15 would have a different end-point. For example, end-point 321.12 is an end-point of candidate line segment 3.12 and end-point 321.15 is an end-point of candidate line segment 3.15. In some embodiments, as shown in FIG. 24, beginning-point-of-origin 311 would be at the side edge line 31 which is representing the beginning of depth section 3.10, and, various end-points such as end-point 321.12 or end-point 321.15 would be at various different points on, side edge line 32 which is representing the end of depth section 3.10. As shown in FIG. 24, it may accordingly result that any various, transformed, pointcloud data point may be touching, or be in some proximal vicinity of a particular candidate line segment, such as for example, as shown in FIG. 24 that transformed, pointcloud data point 1000.62.30 is touching candidate line segment 3.12. In some embodiments, various templates comprising various numbers of laterally oriented, candidate line segments, being at various different angular offsets (among a set of candidate line segments), may be utilised in order to determine a best fit template, to the available data spread, of transformed, pointcloud data points upon a depth section. Consistent with the disclosed embodiments, application processor 324 may perform any analysis with respect to evaluating proximity measurements, of any transformed, pointcloud data point such as transformed, pointcloud data point 1000.62.30 for example, in relation to any of candidate line segments 3.11, 3.12, 3.13, 3.14 and 3.15. In some embodiments, a search region may be associated with each of candidate line segments 3.11, 3.12, 3.13, 3.14 and 3.15.

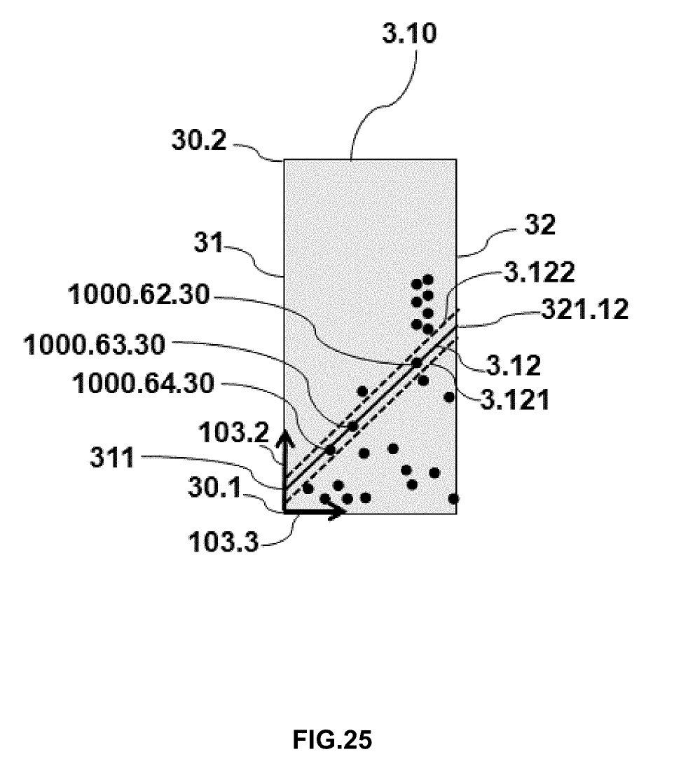

FIG. 25 is a diagrammatic representation of depth section 3.10, consistent with the disclosed embodiments, as shown earlier with reference to FIG. 24, but herein only showing, candidate line segment 3.12, from among candidate lines segments 3.11, 3.12, 3.13, 3.14 and 3.15 shown earlier with reference to FIG. 24. A transformed, pointcloud data point 1000.62.30 is shown on depth section 30 (and was also shown earlier in FIG. 24). Additionally in FIG. 25, a transformed, pointcloud data point 1000.63.30 and a transformed, pointcloud data point 1000.64.30, are also shown as labelled. In some disclosed embodiments, a search region being associated with a candidate line segment may be defined on the basis of a uniformly determined search distance threshold value. In some embodiments, the search distance threshold value may be a perpendicular distance from a candidate line segment. For example, as shown in FIG. 25, a threshold line 3.122 may be at a determined perpendicular distance above candidate line segment 3.12. Also, a threshold line 3.121 may be at a determined perpendicular distance below candidate line segment 3.12 (the two threshold lines 3.122 and 3.121 being at a uniformly determined perpendicular distance, for both above and below, candidate line segment 3.12). It may be noted herein FIG. 25 that there is a count of three, transformed pointcloud data points lying within the search region associated with candidate line segment 3.12 and these three being, transformed, pointcloud data points 1000.62.30, 1000.63.30, and 1000.64.30.

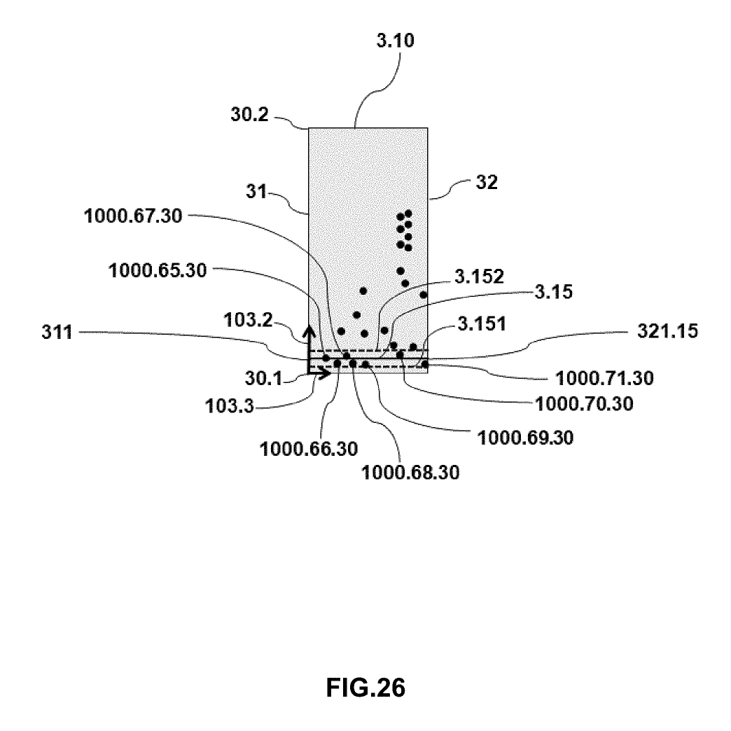

FIG. 26 is a diagrammatic representation of depth section 3.10, consistent with the disclosed embodiments, as shown earlier with reference to FIG. 24, but herein only showing, candidate line segment 3.15, from among candidate lines segments 3.11, 3.12, 3.13, 3.14 and 3.15 shown earlier with reference to FIG. 24. Consistent with the disclosed embodiments, as shown in FIG. 26, a threshold line 3.152 may be at a determined perpendicular distance above candidate line segment 3.15. Also, a threshold line 3.151 may be at a determined perpendicular distance below candidate line segment 3.15 (the two threshold lines 3.152 and 3.151 being at a uniformly determined perpendicular distance, for both above and below, candidate line segment 3.15). It may be noted herein FIG. 26 that there is a count of seven, transformed pointcloud data points lying within the search region associated with candidate line segment 3.15 and these seven being, transformed, pointcloud data points 1000.65.30, 1000.66.30, 1000.67.30, 1000.68.30, 1000.69.30, 1000.70.30, and 1000.71.30.

In some embodiments, a maximal line segment may be selected from among a set of candidate line segments upon a depth section. In some embodiments, the maximal line segment is determined for selection, by counting the number of transformed, pointcloud data points that may be lying within a search region being associated with each of the candidate line segments within the depth section, and therein, the maximal line segment would be the candidate line segment having the maximum count as per said counting. In some disclosed embodiments, a piece-wise linear estimate of the ground profile may be determined, by selecting a maximal line segment from among a set of candidate line segments upon a depth section (for example as per the description of said counting as described with reference to FIG. 25 and FIG. 26). For example, as described and shown with reference to FIG. 25 with respect to candidate line segment 3.12 and as described and shown with reference to FIG. 26 with respect to candidate line segment 3.15, and similarly performing the steps as described for the other candidate line segments 3.11, 3.13, and 3.14 as well, it may be determined that candidate line segment 3.15 would be the maximal line segment on account of candidate line segment 3.15 having the maximum count as per the described counting within the search region, described in detail with reference to FIG. 25 and FIG. 26. Accordingly as well, in some embodiments, candidate line segment 3.15 may serve as a piece-wise linear estimate of the ground profile on account of the candidate line segment 3.15 having been selected as the maximal line segment upon depth section 3.10. Consistent with the disclosed embodiments, this piece-wise linear estimate, as given by candidate line segment 3.15 would accordingly be an estimate pertaining to, a part of the ground surface as represented within segment 3 and corresponding to the measurement of depth section 3.10 along dimension 103.3.

In some embodiments, a composited, piece-wise linear estimate of the ground profile may be determined by associating, two or more piece-wise linear estimates, from two or more consecutive depth sections belonging to the sequence of any number of depth sections upon a virtual plane. For example, consistent with the disclosed embodiments, application processor 324 may determine a composited, piecewise linear estimate of the ground profile by associating a piecewise linear estimate (such as given by candidate line segment 3.15) from depth section 3.10, with, for example, a piece-wise linear estimate that may be determined from the depth section 3.20. In some embodiments, the associating, of, the two or more piece-wise linear estimates, may be by using, an end-point of a piece-wise linear estimate upon a first depth section as a beginning-point-of-origin for determining a piece-wise linear estimate upon a next, sequential depth section.

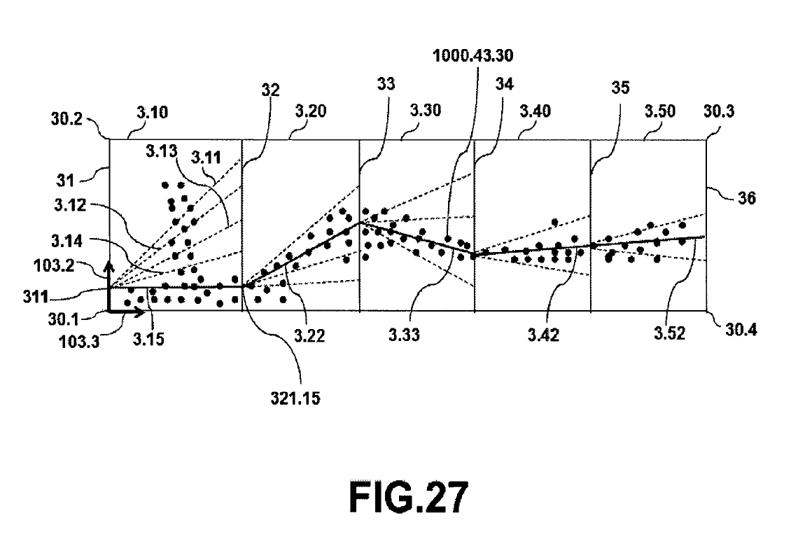

FIG. 27 is a diagrammatic representation of virtual plane 30, consistent with the disclosed embodiments, showing upon virtual plane 30, with a maximal line segment having been determined upon each depth section of a sequence of depth sections 3.10, 3.20, 3.30, 3.40 and 3.50. Corner references 30.1, 30.2, 30.3 and 30.4 may be used to reference the four corners of virtual plane 30, and corner reference 30.1 also serves as a point of origin for measuring the location of any transformed, pointcloud data point, such as e.g. transformed, pointcloud data point 1000.43.30, anywhere along dimensions 103.3 and 103.2 of virtual plane 30. In some embodiments, side edge lines 31 and 32 respectively represent the beginning and end of depth section 3.10, side edge lines 32 and 33 respectively represent the beginning and end of depth section 3.20, side edge lines 33 and 34 respectively represent the beginning and end of depth section 3.30, side edge lines 34 and 35 respectively represent the beginning and end of depth section 3.40, and side edge lines 35 and 36 respectively represent the beginning and end of depth section 3.50.

Consistent with the disclosed embodiments, a maximal line segment 3.15 has been determined with respect to depth section 3.10, a maximal line segment 3.22 is shown to have been determined with respect to depth section 3.20, a maximal line segment 3.33 is shown to have been determined with respect to depth section 3.30, a maximal line segment 3.42 is shown to have been determined with respect to depth section 3.40, and a maximal line segment 3.52 is shown to have been determined with respect to depth section 3.50. Accordingly, in some embodiments, maximal line segments 3.15, 3.22, 3.33, 3.42 and 3.52 would be selected and be determined as various piece-wise linear estimates respectively for depth sections 3.10, 3.20, 3.30, 3.40 and 3.50.

As shown in FIG. 27, on depth section 3.10, candidate line segments 3.11, 3.12, 3.13, 3.14 are shown as dashed lines in order to represent that these candidate line segments (i.e. 3.11, 3.12, 3.13, 3.14) have not been selected as maximal line segment on depth section 3.10. In accordance with the disclosed embodiments, candidate line segments 3.11, 3.12, 3.13, 3.14 and 3.15, (3.15 is shown in FIG. 27 as a solid line on account of being selected as maximal line segment with respect to depth section 3.10 and be determined accordingly as a piece-wise linear estimate with respect to depth section 3.10), all commence at beginning-point-of-origin 311. An end-point 321.15 is an end-point of the piece-wise linear estimate upon depth section 3.10 (being given by candidate line segment 3.15). In some disclosed embodiments, end-point 321.15 may be used as a beginning-point-of-origin for determining a piece-wise linear estimate upon depth section 3.20 (3.20 being the next, sequential depth section after depth section 3.10). Consistent with the disclosed embodiments, piece-wise linear estimate (given by candidate line segment 3.15) upon depth section 3.10 may be associated in this manner with piece-wise linear estimate (given by candidate line segment 3.22) upon depth section 3.20 and accordingly, a continuity of the ground surface may be ascertained on the basis of such association.

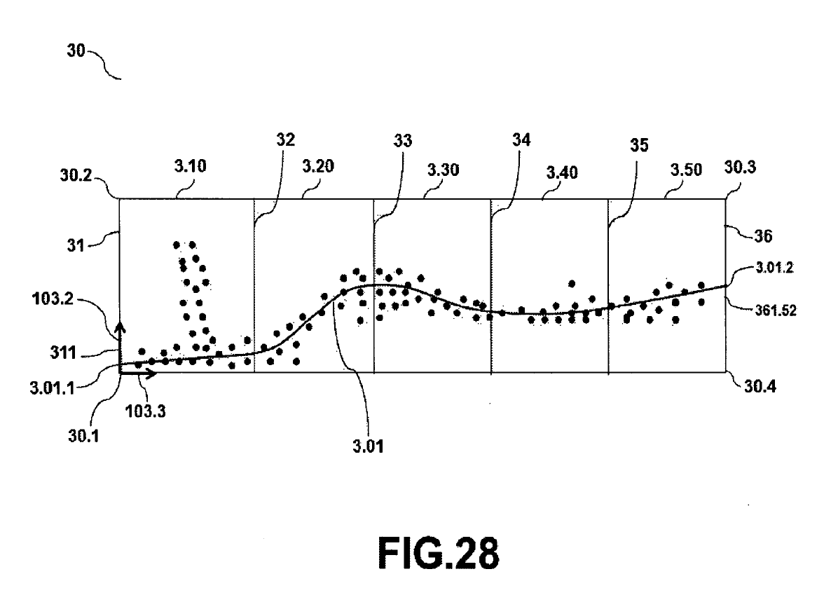

FIG. 28 is a diagrammatic representation of virtual plane 30, consistent with the disclosed embodiments, showing upon the same virtual plane 30, as was shown earlier with reference to FIG. 27, a smoothed ground profile estimate 3.01. In some embodiments, a smoothing function may be applied to all of the piece-wise linear estimates (as shown in FIG. 28), as given by candidate line segments 3.15, 3.22, 3.33, 3.42 and 3.52, that have been determined as maximal line segments therein, respectively in relation to depth sections 3.10, 3.20, 3.30, 3.40 and 3.50), to thereby determine smoothed ground profile estimate 3.01 as shown in FIG. 28. In some other embodiments, a smoothing function may be applied to some of the piece-wise linear estimates (as shown in FIG. 28), as given by candidate line segments 3.15, 3.22, 3.33, 3.42 and 3.52. As would be apparent to one skilled in the art, in some embodiments, an interpolating function may be used to approximate any number of piece-wise linear estimates of the ground profile as a smoothed ground profile estimate. In some embodiments, a smoothing function used for this purpose may be a ‘Lagrange’ interpolating polynomial. In other embodiments a cubic spline curve could be fitted to generate a smoothed ground profile estimate. Consistent with the disclosed embodiments, two smoothed ground profile estimates being respectively from, two or more virtual planes may be joined together (by lateral interpolation for example), thereby developing a ground traversability map. In some embodiments, any two or more piece-wise linear estimates of the ground profile being respectively from two or more virtual planes may be joined (by lateral interpolation as well), thereby developing a ground traversability map.

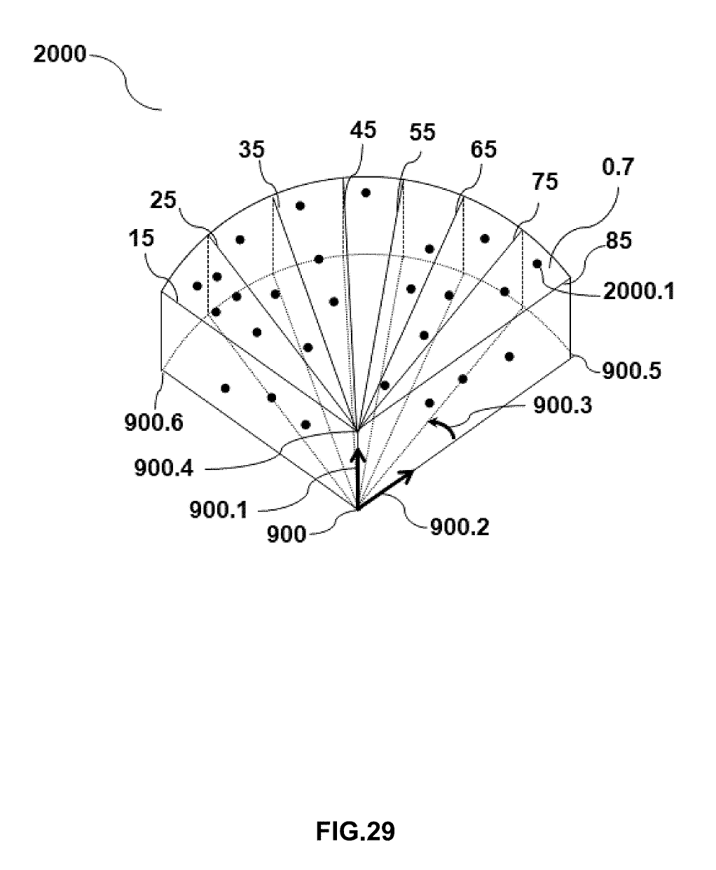

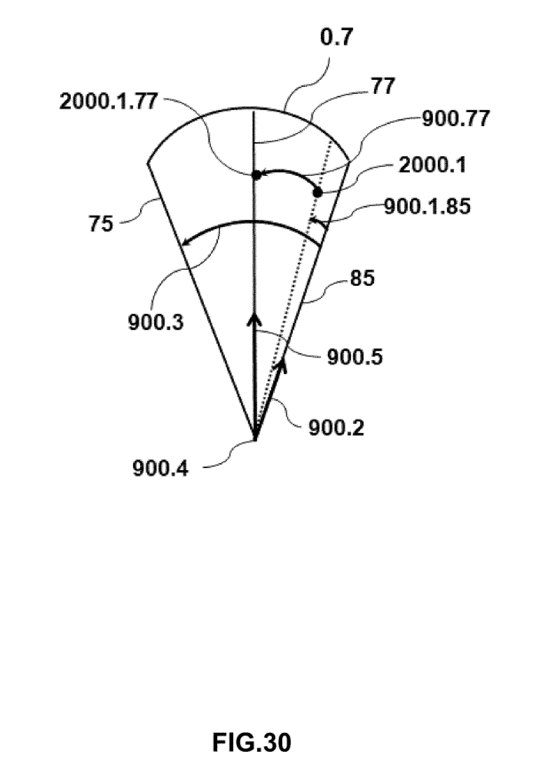

FIG. 29 is a diagrammatic, three-dimensional representation of a radial pointcloud, consistent with the disclosed embodiments. A radial pointcloud 2000 is shown in FIG. 29. A pointcloud data point 2000.1 is shown within radial pointcloud 2000. The three-dimensional location of, a pointcloud data point such as pointcloud data point 2000.1, within radial pointcloud 2000, can be ascertained by knowing its distance, from a point of origin 900, along dimensions 900.1 and 900.2, as well as by knowing its azimuthal angle with respect to any determined edge of radial pointcloud 2000 (for example azimuthal angle 900.1.85 of pointcloud data point 2000.1 as shown in FIG. 30). Consistent with the various disclosed embodiments, as shown in any top-down view of radial pointcloud 2000 (for example as shown in FIG. 8, FIG. 11, and FIG. 12), point of origin 900 (as shown in FIG. 29) for radial pointcloud 2000, may lie vertically below LIDAR 312 as shown for example in FIG. 8, or FIG. 11, or FIG. 12. A point 900.4 is shown vertically above point of origin 900, and in some embodiments, point 900.4 would exactly correspond to a location of LIDAR 312 as shown for example in FIG. 8, or FIG. 11, or FIG. 12. A curved arc of radial pointcloud 2000 may be referenced as lying between corner references 900.5 and 900.6. FIG. 29 shows virtual planes 15, 25, 35, 45, 55, 65, 75, and 85. In some embodiments, a segment 0.7 may be bounded within a virtual plane 85 and a virtual plane 75. Consistent with the disclosed embodiments, any number of contiguous segments (such as segment 0.7) may be determined with respect to radial pointcloud 2000, as lying between any two, contiguously located, virtual planes 15, 25, 35, 45, 55, 65, 75, and 85. In some embodiments, any pointcloud data points of radial pointcloud 2000 may be allocated as pointcloud data points belonging within a particular segment such as for example pointcloud data point 2000.1 may be allocated as belonging within segment 0.7. Segment 0.7 is shown in FIG. 29 as a wedge-shaped segment and segment 0.7 may be itself be determined on the basis of having any suitably determined azimuthal angle 900.3 with respect to virtual plane 85.

FIG. 30 is a diagrammatic, top-view of segment 0.7 of radial pointcloud 2000, consistent with the disclosed embodiments. In some embodiments, 900.3 may be the azimuthal angle of segment 0.7 with respect to virtual plane 85. Also, 900.1.85 may be the azimuthal angle of pointcloud data point 2000.1 as within segment 0.7 with respect to virtual plane 85. Consistent with some disclosed embodiments, pointcloud data point 2000.1 may be transformed on to a virtual plane 77 through radial projection along a radial vector 900.77. Accordingly, in some embodiments, a transformed pointcloud data point 2000.1.77 may result on virtual plane 77. In some embodiments, virtual plane 77 may be laterally centred within segment 0.7 and virtual plane 77 may lie along a dimension 900.5. The movement by way of transformation of, pointcloud 2000.1 from its original location as shown in FIG. 30 at 2000.1 to its transformed location as shown by the location of transformed, pointcloud data point 2000.1.77 would result in the transformed, pointcloud data point retaining the location measurements of pointcloud data point 2000.1 along dimensions 900.1 and 900.2 but relinquishing the precise location measurement in terms of azimuthal angle.

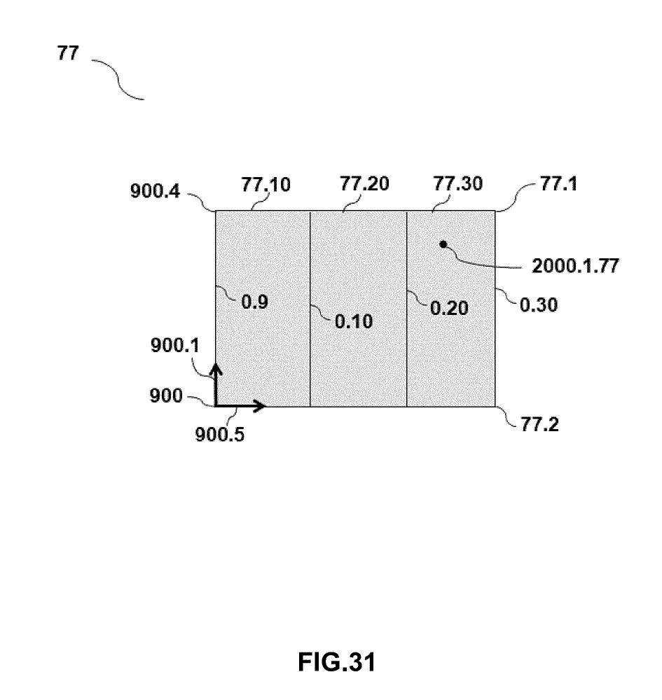

FIG. 31 is a diagrammatic, representation of a full planar view of virtual plane 77, consistent with the disclosed embodiments. FIG. 31 shows a point of origin 900 for virtual plane 77, as well as dimensions 900.1 and 900.5 of virtual plane 77. In some embodiments, corner references 77.1, 77.2, 900.4, and 900 (which is the point of origin of radial pointcloud 2000), may be used to reference the four corners of virtual plane 77. Consistent with the disclosed embodiments, virtual plane 77 may be sectioned into a number of depth sections 77.10, 77.20, 77.30. In some embodiments, depth section 77.10 may lie between side edge lines 0.9 and 0.10, depth section 77.20 may lie between side edge lines 0.10 and 0.20, and depth section 77.30 may lie between side edge lines 0.20 and 0.30. Transformed, pointcloud data point 2000.1.77 is shown as upon depth section 77.30. Consistent with some disclosed embodiments, any pointcloud data point such as pointcloud data point 2000.1 of radial pointcloud 2000, having been allocated as belonging with segment 0.7, may be transformed on to virtual plane 77. Consistent with the disclosed embodiments, any or all of, depth sections 77.10, 77.20, 77.30 on virtual plane 77, or radial pointcloud 2000, may be analysed by application processor 324, in a similar fashion as any of the analyses or steps described in the disclosure in relation to cuboid pointcloud 1000. Consistent with the disclosed embodiments, pointcloud data processor 322, may, perform any pointcloud data processing steps, accordingly as described with respect to any cuboid pointcloud such as cuboid pointcloud 1000, or accordingly as described with respect to any radial pointcloud such as radial pointcloud 2000, in various disclosed embodiments.

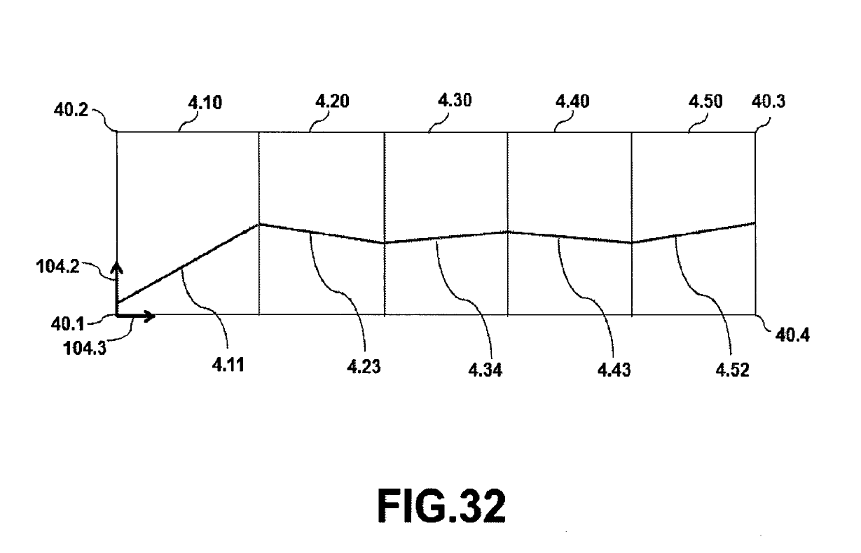

FIG. 32 is a diagrammatic representation of virtual plane 40, of cuboid pointcloud 1000, consistent with the disclosed embodiments. FIG. 32 shows upon virtual plane 40, maximal line segments 4.11, 4.23, 4.34, 4.43, and 4.52, and therein, maximal line segments 4.11, 4.23, 4.34, 4.43, and 4.52, as having been determined, as piece-wise linear estimates of the ground profile, respectively for depth sections 4.10, 4.20, 4.30, 4.40 and 4.50. Corner references 40.1, 40.2, 40.3 and 40.4 may be used to reference the four corners of virtual plane 40. In some disclosed embodiments, a similar analysis as described in this disclosure with reference to segment 3 of cuboid pointcloud 1000, may be performed similarly with respect to segment 4 of cuboid pointcloud 1000, and accordingly, similarly resulting in maximal line segments 4.11, 4.23, 4.34, 4.43, and 4.52, being determined, as piece-wise linear estimates of the ground profile, respectively for depth sections 4.10, 4.20, 4.30, 4.40 and 4.50, all being depth sections of virtual plane 40, and virtual plane 40 herein being the virtual plane on to which, any pointcloud data points allocated as belonging within segment 4 of cuboid pointcloud 1000 (segment 4 as shown in FIG. 15 for example) may have been transformed.

Consistent with the disclosed embodiments, by similarly analysing segments 1 and 2 of cuboid pointcloud 1000 (segments 1 and 2 also as shown in FIG. 15), correspondingly, a plurality of piece-wise linear estimates of the ground profile of various parts of the ground surface may be determined (also herein being with respect to various different virtual planes). Accordingly, in some embodiments, a ground traversability map may be developed by, representing, any number of a plurality of piece-wise linear estimates of the ground profile being respectively from two or more virtual planes, upon the ground surface represented within the pointcloud data received from a sensor (of sensing unit 310), such as LIDAR 312 for example. In some embodiments, a ground traversability map may be developed by, joining, any number of a plurality of piece-wise linear estimates of the ground profile being respectively from two or more virtual planes. Consistent with the disclosed embodiments, any location upon the ground traversability map may be assigned a ground traversability score. In some embodiments, this assignment may be performed by application processor 324 and in some embodiments, a ground traversability score may be derived from the slope angle of one or more of a plurality of piece-wise linear estimates of the ground profile. In some embodiments, a ground traversability score may be assigned based on the slope angle characterising a piece-wise linear estimate.

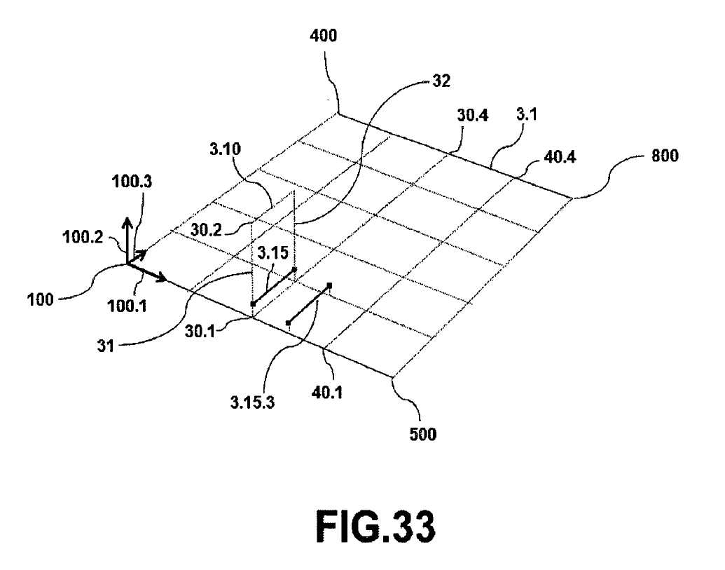

FIG. 33 is a diagrammatic representation of a piece-wise linear estimate of the ground profile from depth section 3.10, therein being represented on a part of the ground surface within cuboid pointcloud 1000, consistent with the disclosed embodiments. As shown in FIG. 33, the ground surface as within cuboid pointcloud 1000 (as shown earlier with reference to FIG. 14) may herein be similarly referenced through corner references 100, 400, 800 and 500, as shown in FIG. 33. Dimensions 100.1, 100.2 and 100.3 (of cuboid pointcloud 1000 are also shown in FIG. 33). Depth section, 3.10 and side edge lines 31 and 32 of depth section 3.10 are also shown. A ground surface 3.1 is a ground surface as within segment 3 of cuboid pointcloud 1000, and ground surface 3.1 is a region as shown in FIG. 33 and being represented within corner references 30.1, 30.4, 40.4 and 40.1. Consistent with some disclosed embodiments, a maximal line segment (as given by candidate line segment 3.15 having been determined as a maximal line segment with respect to depth section 3.10) is shown on depth section 3.10. In some embodiments, a piece-wise linear estimate 3.15.3 would be a corresponding piece-wise linear estimate of the ground profile on a corresponding part of ground surface 3.1 as shown.

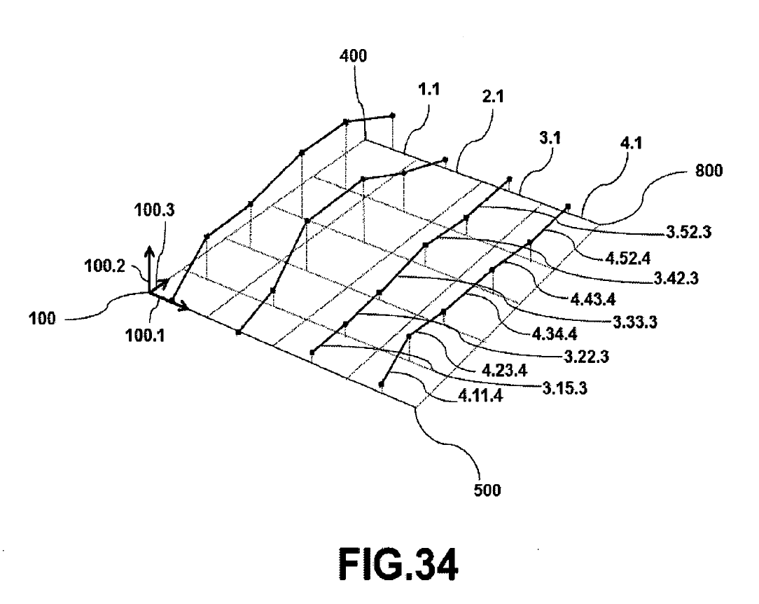

FIG. 34 is a diagrammatic representation of a ground traversability map, as shown on the ground surface within cuboid pointcloud 1000 and the ground surface within cuboid pointcloud 1000 may herein be referenced through corner references 100, 400, 800 and 500, as shown. FIG. 34 shows ground surfaces 1.1, 2.1, 3.1 and 4.1, respectively being ground surfaces as within, segments 1, 2, 3 and 4 of cuboid pointcloud 1000 (and segments 1, 2, 3 and 4 being as shown with reference to FIG. 14). Dimensions 100.1, 100.2 and 100.3 of cuboid pointcloud 1000 are also shown with respect to the ground surface within cuboid pointcloud 1000. A plurality of piece-wise linear estimates 4.11.4, 4.23.4, 4.34.4, 4.43.4 and 4.52.4 are shown upon ground surface 4.1 and in some embodiments, these piece-wise linear estimates upon ground surface 4.1 would respectively be given as per maximal line segments 4.11, 4.23, 4.34, 4.43, and 4.52, having been so determined in relation to virtual plane 40. A plurality of piece-wise linear estimates 3.15.3, 3.22.3, 3.33.3, 3.42.3 and 3.52.3 are shown upon ground surface 3.1 and in some embodiments, these piece-wise linear estimates upon ground surface 3.1 would respectively be given as per maximal line segments 3.15, 3.22, 3.33, 3.42, and 3.52, having been so determined in relation to virtual plane 30. Consistent with some disclosed embodiments, the ground traversability map may be a compendium of any number of piece-wise linear estimates and each piece-wise linear estimate may be embodying various characteristics such as for example, slope angle or piece-wise traversability score. In some disclosed embodiments, any location upon the ground traversability map may be assigned a ground traversability score. In some embodiments, a ground traversability score may be calculated as a simple average or as a weighted average, of two or more piece-wise traversability scores respectively having been assigned to two or more parts of the ground surface. Consistent with the disclosed embodiments, the ground traversability score or the piecewise traversability score may be provided as an input to an autonomous vehicle (such as for example autonomous vehicle 4002 or autonomous vehicle 4006 by their respective system 3000).

As used throughout this disclosure, the term “autonomous vehicle” refers to a vehicle capable of implementing at least one vehicle actuation task, from among a steering actuation task, a throttle actuation task, or a brake actuation task, without driver input. In relation to the definitions of levels of autonomous driving as provided by Society of Automotive Engineers (SAE), any of the automation levels, from Level 1 (driver assistance) to Level 5 (full automation), may be included within the meaning of the term “autonomous vehicle”.

The foregoing description is illustrative. It is not exhaustive and is not limited to the precise forms or embodiments disclosed. Various modifications and adaptations will be apparent to one skilled in the art. Computer programs based on the written description and disclosed methods are within the skill of experienced developers within the field and can be created by a skilled programmer using various programming languages and environments including; C, C++, Objective-C, Go, Robot Operating System (ROS).

Moreover, while illustrative embodiments are described herein, the scope of any and all modifications, omissions, combinations, adaptations, and alterations, as would be appreciated by those skilled in the art is included. The limitations in the claims are to be interpreted broadly based on the language employed in the claims and not limited to examples described in the present specification or during the prosecution of the application. The true scope and spirit is indicated by the appended claims and the full scope of equivalents.

### REFERENCES CITED

Other Publications:
[1] Ingle, A. N., Sethares, W. A Varghese, T. and Bucklew, J. A., 2014, November. Piecewise linear slope estimation, In Conference record/Asilomar Conference on Signals, Systems & Computers Asilomar Conference on Signals, Systems & Computers (Vol. 2014, p. 420). NIH Public Access.

[2] Sahlholm, P., Gattami, A. and Johansson, K. H 2011. Piecewise linear road grade estimation (No 2011-01-1039) SAE Technical Paper.

1. A system of ground surface estimation by an autonomous vehicle, the system comprising:
at least one processing device programmed to:
receive, from a sensor mounted on the autonomous vehicle, a pointcloud that is representative of an environment of the autonomous vehicle;
transform, any pointcloud data points of the pointcloud on to a virtual plane;
section, the virtual plane into a sequence of any number of depth sections;
analyse, a plurality of depth sections to determine correspondingly a plurality of piece-wise linear estimates of the ground profile of various parts of the ground surface;
calculate, a ground surface estimate by combining, any number of piece-wise linear estimates from among the plurality of piece-wise linear estimates of the ground profile.

2. A system of claim 1, wherein the any pointcloud data points of the pointcloud are transformed on to the virtual plane through orthographic projection.

3. A system of claim 1, wherein the any pointcloud data points of the pointcloud are transformed on to the virtual plane through radial projection.

4. A system of claim 1, wherein the any pointcloud data points of the point cloud are referenced in terms of, a three-dimensional Cartesian coordinate frame having a point of origin and an orientation, as determined with respect to a chosen point on the autonomous vehicle.

5. A system of claim 1, wherein the any pointcloud data points of the pointcloud are referenced in terms of, a three-dimensional Polar coordinate frame having a point of origin and an orientation, as determined with respect to a chosen point on the autonomous vehicle.

6. A system of claim 1, wherein a piece-wise linear estimate of the ground profile is determined, by selecting, a maximal line segment from among a set of candidate line segments upon a depth section.

7. A system of claim 6, wherein the maximal line segment is determined for selection, by counting the number of transformed, pointcloud data points of the pointcloud that may be lying within a search region being associated with each of the candidate line segments within the depth section, and therein, the maximal line segment would be the candidate line segment having the maximum count as per said counting.

8. A system of claim 7, wherein the search region being associated with each candidate line segment is defined on the basis of a uniformly determined search distance threshold value.

9. A system of claim 8, wherein the search distance threshold value is a perpendicular distance from a candidate line segment.

10. A system of claim 1, wherein a composited, piece-wise linear estimate of the ground profile is determined by associating, two or more piece-wise linear estimates, from two or more consecutive depth sections belonging to the sequence of any number of depth sections upon the virtual plane.

11. A system of claim 10, wherein the associating, of, the two or more piece-wise linear estimates, is by using, an end-point of a piece-wise linear estimate upon a first depth section as a beginning-point-of-origin for determining a piece-wise linear estimate upon a next, sequential depth section.

12. A system of claim 1, wherein a smoothing function is applied to the any number of piece-wise linear estimates from among the plurality of piece-wise linear estimates of the ground profile, to thereby determine a smoothed ground profile estimate upon the virtual plane.

13. A system of claim 1, wherein any pointcloud data points of the pointcloud are allocated as pointcloud data points belonging within a particular segment wherein the particular segment may be from among a determined plurality of contiguous segments of the pointcloud, and, transforming, any pointcloud data points of the particular segment on to a virtual plane.

14. A system of claim 12 and claim 13, wherein a ground traversability map is developed by joining, two or more smoothed ground profile estimates being respectively from, two or more virtual planes.

15. A system of claim 13, wherein a ground traversability map is developed by joining, two or more of the plurality of piece-wise linear estimates of the ground profile being respectively from two or more virtual planes.

16. A system of claim 14 and claim 15, wherein any location upon the ground traversability map is assigned a ground traversability score.

17. A system of claim 16, wherein the ground traversability score is derived from the slope angle of the one or more of the plurality of piece-wise linear estimates of the ground profile.

18. A system of claim 1, wherein any piece-wise linear estimate from among the plurality of piece-wise linear estimates, is characterised through a slope angle.

19. A system of claim 18, wherein a piece-wise traversability score is assigned to any part of the ground surface, based on the slope angle characterising a piece-wise linear estimate.

20. A system of claim 19, wherein a ground traversability score is calculated, as a simple average or as a weighted average, of two or more piece-wise traversability scores respectively having been assigned to two or more parts of the ground surface.

21. A system of claim 17, claim 19 and claim 20, wherein the ground traversability score or the piece-wise traversability score is provided as an input to a vehicle control system of the autonomous vehicle, while determining an actuation command for the autonomous vehicle.

22. A method of ground surface estimation by an autonomous vehicle, the method comprising:
receiving, from a sensor mounted on the autonomous vehicle, a pointcloud that is representative of an environment of the autonomous vehicle;
transforming, any pointcloud data points of the pointcloud on to a virtual plane;
sectioning, the virtual plane into a sequence of any number of depth sections;
analysing, a plurality of depth sections to determine correspondingly a plurality of piece-wise linear estimates of the ground profile of various parts of the ground surface;
calculating, a ground surface estimate by combining, any number of piece-wise linear estimates from among the plurality of piece-wise linear estimates of the ground profile.

23. A method of claim 22, wherein transforming the any pointcloud data points of the pointcloud on to the virtual plane through orthographic projection.

24. A method of claim 22, wherein transforming the any pointcloud data points of the pointcloud on to the virtual plane through radial projection.

25. A method of claim 22, wherein referencing within the pointcloud, the any pointcloud data points of the point cloud, in terms of a three-dimensional Cartesian coordinate frame having a point of origin and an orientation, as determined with respect to a chosen point on the autonomous vehicle.

26. A method of claim 22, wherein referencing within the pointcloud, the any pointcloud data points of the pointcloud, in terms of a three-dimensional Polar coordinate frame having a point of origin and an orientation, as determined with respect to a chosen point on the autonomous vehicle.

27. A method of claim 22, wherein determining a piece-wise linear estimate of the ground profile, by selecting, a maximal line segment from among a set of candidate line segments upon a depth section.

28. A method of claim 27, wherein determining the maximal line segment for selection, by counting the number of transformed, pointcloud data points of the pointcloud that may be lying within a search region being associated with each of the candidate line segments within the depth section, and therein, the maximal line segment would be the candidate line segment having the maximum count as per said counting.

29. A method of claim 28, wherein defining the search region being associated with each candidate line segment on the basis of a uniformly determined search distance threshold value.

30. A method of claim 29, wherein determining the search distance threshold value as a perpendicular distance from a candidate line segment.

31. A method of claim 22, wherein determining a composited, piece-wise linear estimate of the ground profile by associating, two or more piece-wise linear estimates, from two or more consecutive depth sections belonging to the sequence of any number of depth sections upon the virtual plane.

32. A method of claim 31, wherein the associating, of, the two or more piece-wise linear estimates, is by using, an end-point of a piece-wise linear estimate upon a first depth section as a beginning-point-of-origin for determining a piece-wise linear estimate upon a next, sequential depth section.

33. A method of claim 22, wherein applying a smoothing function to the any number of piece-wise linear estimates from among the plurality of piece-wise linear estimates of the ground profile, thereby determining a smoothed ground profile estimate upon the virtual plane.

34. A method of claim 22, wherein allocating any pointcloud data points of the pointcloud as pointcloud data points belonging within a particular segment wherein the particular segment may be from among a determined plurality of contiguous segments of the pointcloud, and, transforming, any pointcloud data points of the particular segment on to a virtual plane.

35. A method of claim 33 and claim 34, wherein developing a ground traversability map by joining, two or more smoothed ground profile estimates being respectively from, two or more virtual planes.

36. A method of claim 34, wherein developing a ground traversability map by joining, two or more of the plurality of piece-wise linear estimates of the ground profile being respectively from two or more virtual planes.

37. A method of claim 35 and claim 36, assigning a ground traversability score to any location upon the ground traversability map.

38. A method of claim 37, wherein deriving the ground traversability score from the slope angle of the one or more of the plurality of piece-wise linear estimates of the ground profile.

39. A method of claim 22, wherein characterising any piece-wise linear estimate from among the plurality of piece-wise linear estimates through a slope angle.

40. A method of claim 39, wherein assigning a piece-wise traversability score to any part of the ground surface, based on the slope angle characterising a piece-wise linear estimate.

41. A method of claim 40, wherein calculating a ground traversability score, as a simple average or as a weighted average, of two or more piece-wise traversability scores respectively having been assigned to two or more parts of the ground surface.

42. A method of claim 38, claim 40 and claim 41, wherein providing the ground traversability score or the piece-wise traversability score as an input to a vehicle control system of the autonomous vehicle, while determining an actuation command for the autonomous vehicle.
